(19) United States
(12) Patent Application Publication
(10) Pub. No.: US 2025/0112360 A1
(43) Pub. Date: Apr. 3, 2025

(54) Electronic Device

(71) Applicant: Huawei Technologies Co., Ltd., Shenzhen (CN)

(72) Inventors: Pengfei Wu, Shanghai (CN); Wenjun Chen, Wuhan (CN); Hanyang Wang, Reading (GB); Liang Xue, Shanghai (CN)

(21) Appl. No.: 18/980,775

(22) Filed: Dec. 13, 2024

Related U.S. Application Data
(63) Continuation of application No. PCT/CN2023/100909, filed on Jun. 17, 2023.

(30) Foreign Application Priority Data
Jun. 27, 2022 (CN) 202210745490.2
Oct. 27, 2022 (CN) 202211330940.8

(51) Int. Cl. H01Q 1/24; H01Q 1/38; H01Q 13/10; H04M 1/02

(52) U.S. Cl. CPC H01Q 1/243; H01Q 1/38; H01Q 13/106; H04M 1/0274

(57) ABSTRACT

An electronic device includes a housing and a display screen that enclose an internal space. The housing includes a first conducting layer, and the display screen includes a second conducting layer. The first conducting layer and the second conducting layer are layered, and a conducting connection member disposed inside the electronic device is electrically connected between the first conducting layer and the second conducting layer. The first conducting layer, the conducting connection member, and the second conducting layer jointly enclose a cavity with a slot, forming a cavity-backed slot antenna.

### CROSS-REFERENCE TO RELATED APPLICATIONS

This is a continuation of Int'l Patent App. No. PCT/CN2023/100909, filed on Jun. 17, 2023, which claims priority to Chinese Patent App. No. 202210745490.2, filed on Jun. 27, 2022 and Chinese Patent App. No. 202211330940.8, filed on Oct. 27, 2022, both of which are incorporated by reference.

### TECHNICAL FIELD

Embodiments of this application relate to the field of antenna technologies, and in particular, to an electronic device.

### BACKGROUND

With development of communication technologies, a multiple-input multiple-output (MIMO) antenna technology is increasingly widely applied to electronic devices, with an exponentially increasing quantity of antennas and an increasing quantity of covered bands. Electronic device products, especially electronic devices with a metal industry design, still require high structural compactness. However, recent trends in designing an electronic device are a higher screen-to-body ratio, more multimedia components, and a larger battery capacity. These designs greatly compress a space for an antenna.

A slot antenna is an antenna formed by cutting slots on a conductor surface, and an electromagnetic wave radiates to an external space through the slot. Featuring a low profile, an integration capability, and the like, the slot antenna has attracted extensive attention and been extensively studied. For example, if an electronic device is a terminal device (for example, a mobile phone), the slot antenna can radiate through the slot, without a need to add another component inside the mobile phone terminal. This avoids a problem of an insufficient space due to an additional metal strip. Therefore, the slot antenna may be used in the terminal device to implement miniaturization of the terminal device.

How to make use of a limited space of the electronic device and design a wideband cavity-backed slot antenna that can implement a plurality of resonances with single feed is a research interest in the industry.

### SUMMARY

Embodiments of this disclosure provide an electronic device. The electronic device has a cavity-backed slot antenna, and the cavity-backed slot antenna can implement at least two resonances with single feed, providing a good bandwidth.

To achieve the foregoing objective, the following technical solutions are used in this disclosure.

This disclosure provides an electronic device, including a display screen and a housing. The housing and the display screen jointly enclose an internal space of the electronic device, the housing includes a first conducting layer, the display screen includes a second conducting layer, the first conducting layer and the second conducting layer are layered up in a thickness direction of the electronic device, a conducting connection member is disposed inside the electronic device, the conducting connection member is electrically connected between the first conducting layer and the second conducting layer, the first conducting layer, the conducting connection member, and the second conducting layer jointly enclose a cavity, a slot structure is provided on the cavity, the cavity and the slot structure form a cavity-backed slot antenna, a range of a ratio of a length of the cavity to a width of the cavity is greater than or equal to 3, and a length of the slot structure is the same as the length of the cavity. The length of the cavity is a distance from one end to the other end of the cavity along an extension direction of the slot structure, and the width of the cavity is a dimension of the cavity in a direction perpendicular to the extension direction of the slot structure and perpendicular to the thickness direction of the electronic device.

In this disclosure, the cavity-backed slot antenna architecture is constructed in the internal space of the electronic device by using the first conducting layer, the second conducting layer, and the conducting connection member. By limiting the length-width ratio of the cavity, the cavity-backed slot antenna formed by the cavity and the slot structure can generate at least two operating resonances (frequency points) with excitation of one feed signal, providing a good bandwidth feature.

In a possible implementation, the range of the ratio of the length of the cavity to the width of the cavity is greater than or equal to 3 and less than or equal to 10. In this solution, an upper limit (less than or equal to 10) of the length-width ratio of the cavity is provided to limit a space occupied by the cavity-backed slot antenna inside the electronic device, so that an operating bandwidth of an antenna element can be expanded in the limited space, providing high radiation performance.

In a possible implementation, the range of the ratio of the length of the cavity to the width of the cavity is greater than or equal to 4 and less than or equal to 6. In this solution, a balance between dimensions and radiation performance can be achieved, and radiation performance of the antenna element is improved with an appropriate dimension range. On one hand, a space can be saved; on the other hand, it is ensured that the cavity can generate two or three resonance modes.

In a possible implementation, a dimension of the cavity is greater than or equal to 1 mm in the thickness direction of the electronic device. In this solution, the dimension of the cavity in the thickness direction is limited to ensure radiation performance of the cavity-backed slot antenna. In the limited space, a larger dimension of the cavity in the thickness direction indicates higher radiation performance. However, to ensure a design requirement for miniaturization of the electronic device, the dimension of the cavity is limited to be greater than or equal to 1 mm. In other words, both a radiation performance requirement of an antenna and the space design requirement of the electronic device can be satisfied.

In a possible implementation, an operating band of the cavity includes 2.4 gigahertz (GHz), a dimension range of the length of the cavity is greater than or equal to 75 mm and less than or equal to 150 mm, and a dimension range of the width of the cavity is greater than or equal to 15 mm and less than or equal to 30 mm. In this solution, the length range and the width range of the cavity are limited, so that the cavity-backed slot antenna that works in the operating band of 2.4 GHz can be defined.

In a possible implementation, an operating band of the cavity includes 5 GHz, a dimension range of the length of the cavity is greater than or equal to 36 mm and less than or equal to 72 mm, and a dimension range of the width of the cavity is greater than or equal to 7.2 mm and less than or equal to 14.4. In this solution, the length range and the width range of the cavity are limited, so that the cavity-backed slot antenna that works in the operating band of 5 GHz can be defined.

In a possible implementation, the operating band of the cavity includes 2.4 GHz, the dimension range of the length of the cavity is greater than or equal to 75 mm and less than or equal to 100 mm, and the dimension range of the width of the cavity is greater than or equal to 15 mm and less than or equal to 25 mm. In this solution, the length range and the width range of the cavity are limited. Compared with the foregoing implementation, this solution provides a more specific range limit and is also intended to define the cavity-backed slot antenna that works in the operating band of 2.4 GHz.

In a possible implementation, the operating band of the cavity includes 5 GHz, the dimension range of the length of the cavity is greater than or equal to 36 mm and less than or equal to 48 mm, and the dimension range of the width of the cavity is greater than or equal to 7.2 mm and less than or equal to 12 mm. In this solution, the length range and the width range of the cavity are limited. Compared with the foregoing implementation, this solution provides a more specific range limit and is also intended to define the cavity-backed slot antenna that works in the operating band of 5 GHz.

In a possible implementation, the housing is an integrated all-metal rear cover structure, a periphery of the housing and a periphery of the display screen are joined to form an enclosed assembly gap surrounding the display screen, and the slot structure is part of the assembly gap. In this solution, the assembly gap between the display screen and the all-metal rear cover forms the slot structure of the cavity-backed antenna slot, so that a function of the assembly gap is extended, and design costs are reduced. No additional slot structure needs to be provided on the housing of the electronic device, so that integrality of the all-metal rear cover of the electronic device can be ensured, and manufacturing process costs can be reduced. Not only user experience and appearance integrality of the electronic device can be ensured, but the radiation performance of the cavity-backed slot antenna can also be achieved.

Specifically, a width of the slot structure may be greater than or equal to 0.7 mm. In this solution, a width range of the slot structure 30 is limited, so that when the housing and the display screen that are of the electronic device are normally connected, part of the assembly gap between the housing and the display screen has a function of the slot structure of an antenna element, to ensure radiation efficiency of the antenna element. In this solution, a lower limit of the width of the slot structure is provided to ensure the radiation performance of the cavity-backed slot antenna. For the cavity-backed slot antenna, a larger width of the slot structure indicates higher radiation performance.

In a specific implementation, the width of the slot structure is 1.5 mm. In this solution, a specific value of the slot structure is limited to 1.5 mm. For the assembly gap, because the dimension is limited to 1.5 mm, a requirement for assembling the display screen and the housing can be satisfied, and the cavity-backed slot antenna can have high radiation performance.

In a specific implementation, the electronic device includes a feed unit, the feed unit is inside the cavity, the feed unit includes a feed port, the first conducting layer includes a bottom part and a lateral part, the bottom part is opposite to and spaced from the second conducting layer, the lateral part is connected between the bottom part and the periphery of the display screen, a vertical distance between the feed port and the second conducting layer is a first distance, a vertical distance between the feed port and the bottom part is a second distance, and a vertical distance between the feed port and the lateral part is a third distance.

If the first distance is the largest among the first distance, the second distance, and the third distance, the feed port feeds the second conducting layer; or if the third distance is the largest among the first distance, the second distance, and the third distance, the feed port feeds the lateral part of the first conducting layer; or if the second distance is the largest among the first distance, the second distance, and the third distance, the feed port feeds the bottom part of the first conducting layer. In this solution, the feed port is limited to feeding toward the first conducting layer or the second conducting layer that is relatively far away, so that radiation efficiency of the cavity satisfies a requirement, and a bandwidth is easily ensured.

In a specific implementation, the display screen includes a top edge, a bottom edge, and a lateral edge connected between the top edge and the bottom edge, and the slot structure is straight and is formed on the lateral edge or the top edge. The slot structure provided in this embodiment is part of the assembly gap between the display screen and the housing. The assembly gap is positioned around the display screen. The slot structure is straight, and may be on the lateral edge or the top edge of the display screen.

In a specific implementation, the display screen includes a first edge and a second edge adjacent to each other, the slot structure is bent and is in a connection area between the first edge and the second edge, part of the slot structure is formed on the first edge, and part of the slot structure is formed on the second edge. The slot structure provided in this solution may be at an edge position in a corner of the display screen, that is, in the connection area between the first edge and the second edge. This solution can easily achieve a miniaturization design. In addition, a position in a corner of the display screen is usually disposed with a relatively small quantity of other components, and a space can be left to design the cavity and form the cavity-backed slot antenna.

In a specific implementation, the display screen includes a first edge, a second edge, and a third edge sequentially connected, the first edge is opposite to the third edge, the slot structure is half-encircling, part of the slot structure is on the first edge, part of the slot structure is on the second edge, and part of the slot structure is on the third edge. This solution provides a U-shaped slot structure with a relatively large length-width ratio and a capability to generate a large quantity of resonance frequency points.

In a specific implementation, the conducting connection member is part of an assembly frame inside the electronic device, and the assembly frame is any one of or a combination of at least two of a battery compartment, a middle frame, and a camera assembly frame. In an implementation, the conducting connection member and the battery compartment are connected to each other and form a whole. The conducting connection member may be a metal elastic sheet structure, a metal wall, or a metal column structure. When the battery compartment is mounted in the electronic device, it is ensured that two ends of the conducting connection member abut against the first conducting layer and the second conducting layer, to form a cavity architecture. In this solution, the conducting connection member and the battery compartment are disposed as an integrated structure to facilitate assembly and fixing. The battery compartment can be used as a battery holder, and can also fix the conducting connection member. In this way, the battery compartment has dual functions, not only helping save a space to implement a miniaturization design, but also helping ensure structural stability of the conducting connection member.

In a specific implementation, a circuit board is disposed inside the electronic device, at least part of the circuit board is inside the cavity, and the circuit board is configured to dispose the feed unit; at least part of the conducting connection member is connected to the circuit board, and the conducting connection member includes a first conducting member and a second conducting member; one end of the first conducting member is fixed to one surface of the circuit board, and the other end of the first conducting member is electrically connected to the first conducting layer; one end of the second conducting member is fixed to the other surface of the circuit board, and the other end of the second conducting member is electrically connected to the second conducting layer; and the first conducting member is electrically connected to the second conducting member through a line inside the circuit board. In this solution, the conducting connection member is integrated onto the circuit board, and the cavity can be constructed by assembling the circuit board. The first conducting member and the second conducting member may be fixed onto the circuit board through a mounting process. The circuit board is used as a necessary structure for holding a feed unit. In this solution, the conducting connection member is connected to the circuit board, and no other fixing structure needs to be added to fix the conducting connection member. This helps save a space, can easily implement miniaturization of the electronic device, and ensures structural stability of the conducting connection member. The first conducting member and the second conducting member may be elastic sheet structures that elastically abut against the first conducting layer and the second conducting layer, so that the cavity can have a continuous electric connection function, to ensure stability of the radiation performance of the cavity-backed slot antenna.

In a specific implementation, at least part of the conducting connection member includes a plurality of connection subunits, at least one of the connection subunits is disposed at each edge in a width direction of the cavity, and a distance between adjacent connection subunits is less than or equal to half of a wavelength corresponding to a center frequency of the operating band of the cavity.

In a specific implementation, when the range of the ratio of the length of the cavity to the width of the cavity is greater than or equal to 3 and less than or equal to 7, the cavity is capable of generating two or three resonance modes within 50% of a bandwidth of a lowest resonance frequency of the cavity.

In a specific implementation, when the range of the ratio of the length of the cavity to the width of the cavity is greater than 7 and less than or equal to 10, the cavity is capable of generating four or more resonance modes within 50% of a bandwidth of a lowest resonance frequency of the cavity.

In a specific implementation, a connection member is disposed inside the cavity, the connection member includes a conductive material and two ends of the connection member are connected to the first conducting layer and the second conducting layer respectively, and a distance between the connection member and one end of the cavity is less than or equal to 0.25 times the length of the cavity in a length direction of the cavity. In this solution, the connection member is disposed inside the cavity, so that low-frequency performance can be maintained, and high-frequency performance can be optimized. The connection member may be a conductive structure, for example, a metal column or a metal elastic sheet.

In a specific implementation, an operating frequency of the cavity includes a first frequency and a second frequency, the second frequency is higher than the first frequency, and the connection member does not affect radiation performance at the first frequency, and is capable of optimizing radiation performance at the second frequency.

In a specific implementation, the cavity and the slot structure form a first antenna element, the electronic device further includes a second antenna element, the second antenna element includes a second conducting connection member, the second conducting connection member is electrically connected between the first conducting layer and the second conducting layer, the first conducting layer, the second conducting connection member, and the second conducting layer jointly enclose a second cavity, a second slot structure is provided on the electronic device, the second cavity and the second slot structure form a cavity-backed slot antenna, the second antenna element and the first antenna element are adjacent to each other with a spacing component in between, and the spacing component includes a conductive material. The spacing component is configured to improve isolation between the second antenna element and the first antenna element.

In a specific implementation, the spacing component is a metal column electrically connected between the first conducting layer and the second conducting layer.

### BRIEF DESCRIPTION OF DRAWINGS

FIG. 1 is a schematic exploded view of a structure of an electronic device according to an embodiment;

FIG. 2A is a lateral view in an implementation of the electronic device shown in FIG. 1;

FIG. 2B is a lateral view in another implementation of the electronic device shown in FIG. 1;

FIG. 2C is a diagram of a rear cover of an electronic device according to an implementation;

FIG. 2D is a diagram of a middle frame of an electronic device according to an implementation;

FIG. 3 is a diagram of an electronic device according to an implementation;

FIG. 4 is a schematic enlarged view of a part I shown in FIG. 3;

FIG. 5 is a diagram of an electronic device according to an implementation;

FIG. 6A is a schematic enlarged view of a part II in FIG. 5;

FIG. 6B is a schematic enlarged view of a part III shown in FIG. 5;

FIG. 7 is a diagram of a cross-section of an electronic device according to an implementation;

FIG. 8 is a plane diagram of an internal structure of an electronic device according to an implementation;

FIG. 9A and FIG. 9B show a straight bar-shaped cavity according to an implementation, where FIG. 9A is a diagram of a cavity and a current flow direction on the cavity in a state in a first resonance mode, and FIG. 9B is a diagram of a cavity and a current flow direction on the cavity in a state in a second resonance mode;

FIG. 10A and FIG. 10B show a cavity in a bent form according to an implementation, where FIG. 10A is a diagram of a cavity and a current flow direction on the cavity in a state in a first resonance mode, and FIG. 10B is a diagram of a cavity and a current flow direction on the cavity in a state in a second resonance mode;

FIG. 11A and FIG. 11B show a cavity that is bent and half-encircling according to an implementation, where FIG. 11A is a diagram of a cavity and a current flow direction on the cavity in a state in a first resonance mode, and FIG. 11B is a diagram of a cavity and a current flow direction on the cavity in a state in a second resonance mode;

FIG. 12A is a plane diagram of an electronic device according to an implementation;

FIG. 12B is a diagram of a width of an assembly gap between a periphery of a second conducting layer of a display screen and a periphery of a housing shown in an implementation of FIG. 12A;

FIG. 13 is a diagram of part of a sectional view of an electronic device according to an implementation;

FIG. 14A is a diagram of a cavity of specific dimensions in an electronic device according to an implementation;

FIG. 14B is a diagram of an implementation in which two ends of a conducting connection member in an electronic device are electrically connected to a first conducting layer and a second conducting layer respectively according to an implementation;

FIG. 14C is a diagram of an implementation in which two ends of a conducting connection member in an electronic device are electrically connected to a second conducting layer and a circuit board respectively according to an implementation;

FIG. 14D is a diagram of an implementation in which two ends of a conducting connection member in an electronic device are electrically connected to a first conducting layer and a circuit board respectively according to an implementation;

FIG. 15A is a diagram of comparison between S11 parameter distribution diagrams in the implementations shown in FIG. 14B, FIG. 14C, and FIG. 14D;

FIG. 15B is a diagram of comparison between antenna radiation efficiency in the implementations shown in FIG. 14B, FIG. 14C, and FIG. 14D;

FIG. 16A, FIG. 16B, and FIG. 16C are diagrams of feeding solutions in three specific implementations of an electronic device according to this disclosure;

FIG. 17A is a diagram of comparison between S11 parameter distribution diagrams in the implementations shown in FIG. 16A, FIG. 16B, and FIG. 16C;

FIG. 17B is a diagram of comparison between antenna radiation efficiency in the implementations shown in FIG. 16A, FIG. 16B, and FIG. 16C;

FIG. 18A, FIG. 18B, and FIG. 18C are diagrams of different designs of a specific position of a circuit board in three specific implementations of an electronic device according to this disclosure;

FIG. 19A is a diagram of comparison between S11 parameter distribution diagrams in the implementations shown in FIG. 18A, FIG. 18B, and FIG. 18C;

FIG. 19B is a diagram of comparison between antenna radiation efficiency in the implementations shown in FIG. 18A, FIG. 18B, and FIG. 18C;

FIG. 20A is a diagram of current distribution in three resonance modes that can be generated by an antenna element, formed by a cavity and a slot structure of an electronic device according to this disclosure, in an operating band;

FIG. 20B is a diagram of electric field distribution in three resonance modes that can be generated by an antenna element, formed by a cavity and a slot structure of an electronic device according to this disclosure, in an operating band;

FIG. 21A is a diagram of comparison between S11 parameter distribution diagrams of three antenna elements formed by cavities with different length-width ratios;

FIG. 21B is a diagram of comparison between antenna radiation efficiency of three antenna elements formed by cavities with different length-width ratios;

FIG. 22A is a diagram of comparison between S11 parameter distribution diagrams of three antenna elements formed by cavities with different length-width ratios;

FIG. 22B is a diagram of comparison between antenna radiation efficiency of three antenna elements formed by cavities with different length-width ratios;

FIG. 23 is a diagram of electric field distribution in five resonance modes that can be generated by an antenna element according to an implementation;

FIG. 24 is a diagram of a connection member disposed inside a cavity of an electronic device according to an implementation;

FIG. 25 is a diagram of a connection member disposed inside a cavity of an electronic device according to an implementation;

FIG. 26A is a diagram of comparison between S11 parameter distribution diagrams of antenna elements according to two specific implementations (that is, a solution in which no connection member is disposed and a solution in which a connection member is disposed);

FIG. 26B is a diagram of comparison between antenna radiation efficiency of antenna elements according to two specific implementations (that is, a solution in which no connection member is disposed and a solution in which a connection member is disposed);

FIG. 26C is a diagram of current distribution in three resonance modes generated by a cavity with a connection member according to the implementations shown in FIG. 24 and FIG. 25;

FIG. 26D is a diagram of electric field distribution in three resonance modes generated by a cavity with a connection member according to the implementations shown in FIG. 24 and FIG. 25;

FIG. 27 is a diagram of a first antenna element and a second antenna element inside an electronic device according to an implementation;

FIG. 28A is a diagram of comparison between S11 parameter distribution diagrams of the two antenna elements in FIG. 27;

FIG. 28B is a diagram of comparison between antenna radiation efficiency of the two antenna elements in FIG. 27;

FIG. 29 is a diagram of a first antenna element and a second antenna element of an electronic device and a spacing component between the first antenna element and the second antenna element according to an implementation;

FIG. 30A is a diagram of S parameters of the first antenna element and the second antenna element in FIG. 29;

FIG. 30B is a diagram of comparison between antenna radiation efficiency of the first antenna element and the second antenna element in FIG. 29;

FIG. 31A is a diagram of a cross-section of an electronic device according to an implementation;

FIG. 31B is a diagram of a cross-section of an electronic device according to an implementation;

FIG. 31C is a diagram of a cross-section of an electronic device according to an implementation;

FIG. 32A is a diagram of comparison between S curves of antenna elements according to the implementations shown in FIG. 31A, FIG. 31B, and FIG. 31C;

FIG. 32B is a diagram of comparison between radiation efficiency of antenna elements according to the implementations shown in FIG. 31A, FIG. 31B, and FIG. 31C;

FIG. 33 is a diagram of a structure in which a conducting connection member and a battery compartment in an electronic device are connected to each other according to an implementation;

FIG. 34 is a diagram of a structure in which a conducting connection member and a circuit board in an electronic device are connected to each other according to an implementation; and

FIG. 35 is a diagram of a conducting connection member in an electronic device including a plurality of connection subunits according to an implementation.

### DESCRIPTION OF EMBODIMENTS

Terms that may be used in embodiments of this disclosure are explained below.

Parallel: Being parallel as defined in this disclosure is not limited to being absolutely parallel. The definition of being parallel may be understood as being approximately parallel, and an error within a small angle range is allowed when a case of not being absolutely parallel is due to factors such as an assembly tolerance, a design tolerance, and a structural flatness. For example, any assembly error within 10 degrees can be understood as a relationship of being parallel.

Vertical: Being vertical as defined in this application is not limited to an absolute vertical intersection (with an included angle of 90 degrees) relationship, and an error within a small angle range is allowed when a non-absolute vertical intersection relationship is due to factors such as an assembly tolerance, a design tolerance, and a structural flatness. For example, any assembly error ranges from 80 degrees to 100 degrees can be understood as a relationship of being vertical.

Electric connection: The connection may be understood as a physical contact and electrical conduction between elements or components, or may be understood as a form of a connection between different elements or components in a line structure by using a physical line capable of transmitting an electrical signal, for example, a printed circuit board (PCB) copper foil or a wire. The “connection” means a connection in a mechanical structure or a physical structure.

Coupling: Coupling is a phenomenon that two or more circuit elements or electrical networks closely cooperate with and affect each other in input and output, so that energy is transmitted from one side to another side through interaction.

Interconnection: Two or more elements or components are conducting or interconnected through the foregoing “electrical connection” or “coupling” connection, to perform signal/energy transmission. This may be referred to as the interconnection.

Antenna pattern: The antenna pattern is also referred to as a radiation pattern. The antenna pattern is a pattern in which relative field strength (a normalized modulo value) of a radiation field of an antenna changes with a direction away from the antenna, and is usually a representation of two plane patterns that are perpendicular to each other in a direction of maximum radiation of the antenna.

The antenna pattern usually includes a plurality of radiation beams. A radiation beam with highest radiation strength is referred to as a main lobe, and other radiation beams are referred to as side lobes or sidelobes. In the side lobes, a side lobe in a direction opposite to that of the main lobe is also referred to as a back lobe.

Antenna return loss: The antenna return loss may be understood as a ratio of a power of a signal reflected back to an antenna port by an antenna circuit to a transmit power of the antenna port. A smaller reflected signal indicates a larger signal radiated by an antenna into space and higher radiation efficiency of the antenna. A larger reflected signal indicates a smaller signal radiated by the antenna into space and lower radiation efficiency of the antenna.

The antenna return loss may be represented by an S11 parameter, and the S11 parameter is usually a negative number. A smaller S11 parameter indicates a smaller antenna return loss and higher antenna radiation efficiency; and a larger S11 parameter indicates a larger antenna return loss and lower antenna radiation efficiency.

Antenna isolation: The antenna isolation is a ratio of a power of a signal transmitted by one antenna to a power of a signal received by another antenna.

Antenna system efficiency: The antenna system efficiency is a ratio of a power radiated by an antenna into space (that is, a power for effectively converting an electromagnetic wave) to an input power of the antenna.

Antenna radiation efficiency: The antenna radiation efficiency is a ratio of a power radiated by an antenna into space (that is, a power for effectively converting an electromagnetic wave) to an active power input to the antenna. The active power input to the antenna is equal to the input power of the antenna minus an antenna loss. The antenna loss mainly includes an ohmic loss of metal and/or a dielectric loss.

Operating band: An antenna module belongs to a radio frequency system. The radio frequency system needs to work within a specific frequency range to communicate with another device, and the range of the operating frequency of the radio frequency system is referred to as the operating band.

Operating resonance: The operating resonance is a resonance generated by an antenna element in an operating band.

Antenna gain: The Antenna gain indicates how strong an antenna radiates an input power in a specified direction. Generally, a narrower main lobe in an antenna pattern indicates a smaller side lobe and a higher antenna gain.

Isolation: The isolation is a ratio of a power of a signal transmitted by one antenna to a power of a signal received by another antenna. The isolation may be represented by using S21 and S12 parameters.

To make the objectives, technical solutions, and advantages of this disclosure clearer, this disclosure is further described below in detail with reference to the accompanying drawings.

The terms “first”, “second”, and the like used below are merely intended for a purpose of description, and shall not be understood as an indication or implication of relative importance or an implicit indication of a quantity of indicated technical features. Therefore, a feature limited by “first”, “second”, and the like may explicitly indicate or implicitly include one or more such features. In the descriptions of this disclosure, unless otherwise stated, “a plurality of” means two or more.

In addition, in this disclosure, the terms of direction “top”, “bottom”, and the like are defined relative to directions in which components are schematically placed in the accompanying drawings. It should be understood that these terms of direction are relative concepts used for relative description and clarification, and may change correspondingly based on changes of the directions in which the components in the accompanying drawings are placed.

Embodiments of this disclosure provide an electronic device. The electronic device includes, for example, a mobile phone, a tablet computer, a vehicle-mounted computer, an intelligent wearable product, and an internet of things (IoT). A specific form of the electronic device is not particularly limited in embodiments of this disclosure. For ease of description, an example in which the electronic device is a mobile phone is used below for description.

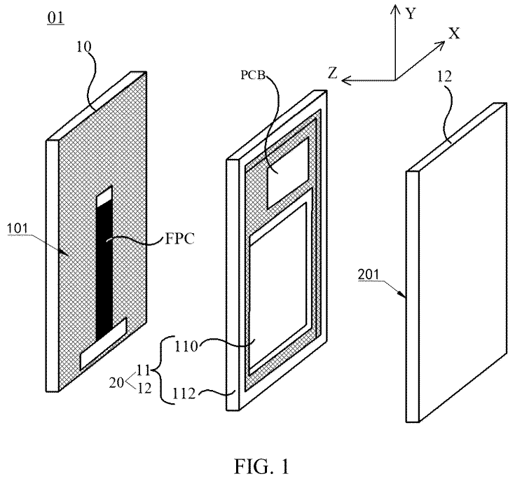

In an implementation, as shown in FIG. 1, an electronic device 01 mainly includes a display screen 10, a middle frame 11, and a rear cover 12. The middle frame 11 is between the display screen 10 and the rear cover 12. FIG. 1 is merely a diagram showing examples of the display screen 10, the middle frame 11, and the rear cover 12 in a decomposed state. Specific structural forms of the display screen 10, the middle frame 11, and the rear cover 12 are not limited in the implementation shown in FIG. 1. The rear cover 12 may be a metal rear cover made of an all-metal material.

The display screen 10 is configured to display an image. In some embodiments, the display screen 10 includes a liquid crystal display (LCD) unit and a back light unit (BLU). Alternatively, in some other embodiments, the display screen 10 may be an organic light-emitting diode (OLED) display screen.

The middle frame 11 includes a support substrate 110 and a conducting frame 112 that is positioned around the support substrate 110. In some embodiments, the conducting frame 112 may be a conducting frame integrally formed on the support substrate 110. It should be understood that, in some other embodiments, the conducting frame 112 and the support substrate 110 may alternatively be separate from each other. For example, the conducting frame 112 and the support substrate 110 may be separately formed by using different materials. For example, the conducting frame 112 is formed by using a conductive material, and the support substrate 110 is formed by using a non-conductive material.

Electronic components such as a printed circuit board (PCB), a camera, and a battery may be disposed on a surface that is of the support substrate 110 and that faces the rear cover 12. The camera and the battery are not shown in the figure. The rear cover 12 is connected to the middle frame 11 to form an accommodation cavity for accommodating the electronic components such as the PCB, the camera, and the battery. The rear cover 12 is hermetically connected to the middle frame 11 (the rear cover 12 and the middle frame 11 may also be an integrated structure), to prevent water vapor and dust from outside from entering the accommodation cavity and affecting performance of the foregoing electronic components.

The display screen 10, the middle frame 11, and the rear cover 12 may be separately disposed in different layers in a thickness direction (a Z direction) of the electronic device. These layers may be parallel to each other. A plane in which each layer is located may be referred to as an X-Y plane, and a direction perpendicular to the X-Y plane may be referred to as the Z direction. In other words, the display screen 10, the middle frame 11, and the rear cover 12 may be distributed in layers in the Z direction. The display screen 10 may be electrically connected to the PCB on the support substrate 110 after a flexible printed circuit (FPC) shown in FIG. 1 passes through the support substrate 110. In this way, the PCB can transmit display data to the display screen 10, to control the display screen 10 for image display.

In the implementation shown in FIG. 1, the middle frame 11 and the rear cover 12 together form a housing 20 of the electronic device. The housing 20 and the display screen 10 jointly enclose an internal space of the electronic device 01. The housing 20 includes a first conducting layer 201, and the first conducting layer 201 may be part of an area of the rear cover 12, for example, an edge area of the rear cover 12. In a specific implementation, the rear cover 12 is an integrated metal structure, and the first conducting layer 201 is part of the rear cover 12. In another implementation, the rear cover 12 may alternatively include a non-metal main part, and the first conducting layer 201 may be disposed on an inner surface of the non-metal main part. The display screen 10 includes a second conducting layer 101 facing the middle frame 11. The second conducting layer 101 may be made of a metal material, or the second conducting layer 101 may be a shield layer of the display screen 10, and is configured to prevent the display screen 10 from being interfered by another component inside the electronic device 01.

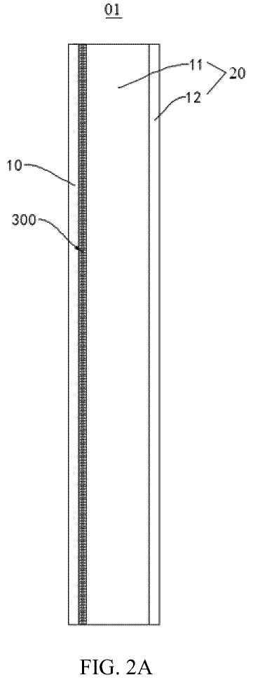

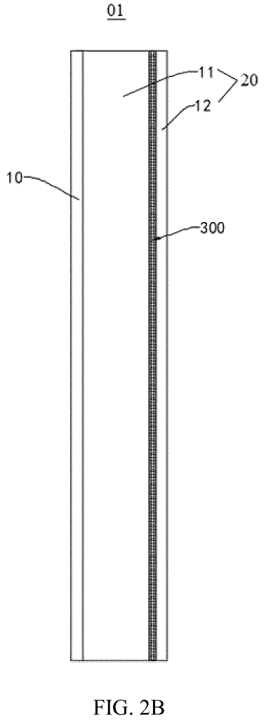

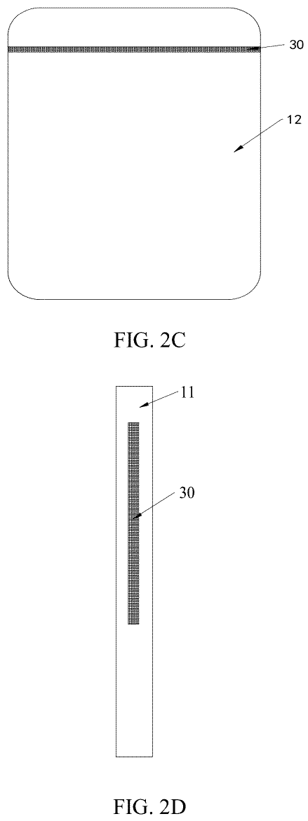

FIG. 2A is a lateral view in an implementation of the electronic device shown in FIG. 1. As shown in FIG. 2A, the electronic device 01 is provided with an assembly gap 300. The assembly gap 300 may be a gap at a joint between the display screen 10 and the middle frame 11, and the assembly gap 300 may be a gap filled with an insulating medium. For example, in an implementation, with reference to FIG. 1, the assembly gap 300 is a non-conductive structure formed between a periphery of the second conducting layer 101 of the display screen 10 and the middle frame 11, and may also be referred to as a black edge at an edge position around the display screen 10. The assembly gap 300 may be positioned around the display screen 10. Part of the assembly gap 300 in this implementation may be used as a path of a cavity-backed antenna inside the electronic device for electromagnetic wave radiation to the outside, and is used as part of the cavity-backed antenna.

FIG. 2B is a lateral view in another implementation of the electronic device shown in FIG. 1. As shown in FIG. 2B, the assembly gap 300 may alternatively be a non-conductive structure at a joint between the middle frame 11 and the rear cover 12. Similarly, part of the assembly gap 300 in this implementation may be used as a path of a cavity-backed antenna inside the electronic device for electromagnetic wave radiation to the outside, and is used as part of the cavity-backed antenna.

FIG. 2C is a diagram of the rear cover 12 of the electronic device according to an implementation. As shown in FIG. 2C, a slot structure 30 may be provided on the rear cover 12. For example, all parts on the rear cover 12 except the slot structure 30 are made of metal materials, and the slot structure 30 is formed by cutting off part of the materials on the integrated metal rear cover and filling an insulating medium. A specific form of the slot structure 30 on the rear cover 12 is not limited in this application. The slot structure 30 may be straight, curved, L-shaped, or the like. The slot structure 30 in this implementation may be used as a path of the cavity-backed antenna inside the electronic device for electromagnetic wave radiation to the outside, and is used as part of the cavity-backed antenna.

FIG. 2D is a diagram of the middle frame 11 of the electronic device according to an implementation. As shown in FIG. 2D, the slot structure 30 may alternatively be provided on the middle frame 11, for example, by cutting a slot on the middle frame 11 and filling an insulating medium (for example, the insulating medium is a ceramic material). Similar to the implementation shown in FIG. 2C, the slot structure 30 in this implementation may be used as a path of the cavity-backed antenna inside the electronic device for electromagnetic wave radiation to the outside, and is used as part of the cavity-backed antenna.

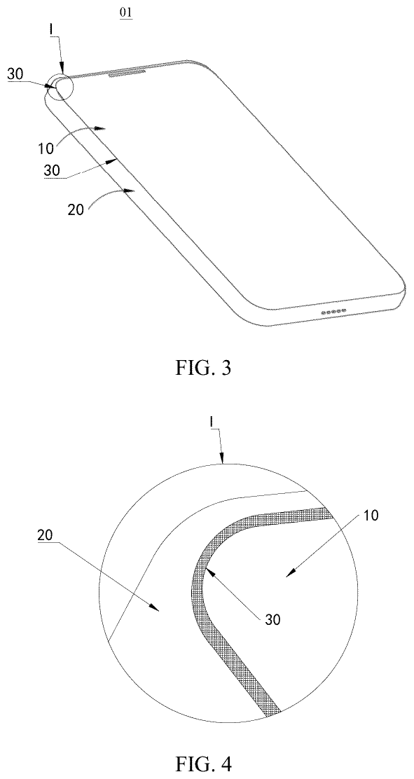

FIG. 3 is a diagram of an electronic device according to an implementation. A main difference between the implementation shown in FIG. 3 and the implementation shown in FIG. 1 lies in that: In the implementation shown in FIG. 3, an electronic device 01 includes a display screen 10 and a housing 20. The housing 20 is an integrated metal rear cover structure. A periphery of the housing 20 and a periphery of the display screen 10 are joined, and an assembly gap 300 is formed between the periphery of the housing 20 and the periphery of the display screen 10. Part of the assembly gap 300 may be used as a path for electromagnetic wave radiation between a cavity inside the electronic device and the outside, that is, a slot structure 30. FIG. 4 is a schematic enlarged view of a part I shown in FIG. 3. In this implementation, the assembly gap 300 may include a straight-line segment and a curve segment. The assembly gap 300 is positioned around the display screen 10, and the slot structure 30 may be located on the straight-line segment or the curve segment of the assembly gap 300, or the slot structure 30 extends from the straight-line segment to the curve segment (for example, the slot structure 30 shown in a part in a circle marked by I in FIG. 3). In an implementation in which the slot structure 30 is straight, the display screen 10 includes a top edge, a bottom edge, and a lateral edge connected between the top edge and the bottom edge, and the slot structure 30 is straight and is formed on the lateral edge or the top edge. In an implementation in which the slot structure 30 is curved, the display screen 10 includes a first edge and a second edge adjacent to each other, and the slot structure is bent and is in a connection area between the first edge and the second edge. Part of the slot structure is formed on the first edge, and part of the slot structure is formed on the second edge. The slot structure provided in this solution may be at an edge position in a corner of the display screen, that is, in the connection area between the first edge and the second edge. This solution can easily achieve a miniaturization design. In addition, a position in a corner of the display screen is usually disposed with a relatively small quantity of other components, and a space can be left to design the cavity and form the cavity-backed slot antenna.

In a specific implementation, the display screen includes a first edge, a second edge, and a third edge sequentially connected, the first edge is opposite to the third edge, the slot structure is half-encircling, part of the slot structure is on the first edge, part of the slot structure is on the second edge, and part of the slot structure is on the third edge. This solution provides a U-shaped slot structure with a relatively large length-width ratio and a capability to generate a large quantity of resonance frequency points.

In the implementation shown in FIG. 3, the slot structure 30 may alternatively be formed on the housing 20. In this implementation, the electronic device 01 also includes a first conducting layer and a second conducting layer. For example, the second conducting layer is a shield layer structure of the display screen 10, the first conducting layer is part of the housing 20, and the housing 20 may be an integrated structure made of an all-metal material.

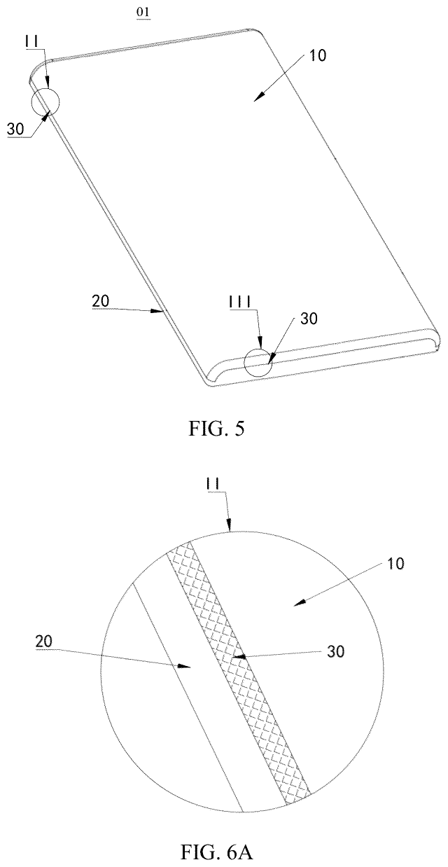

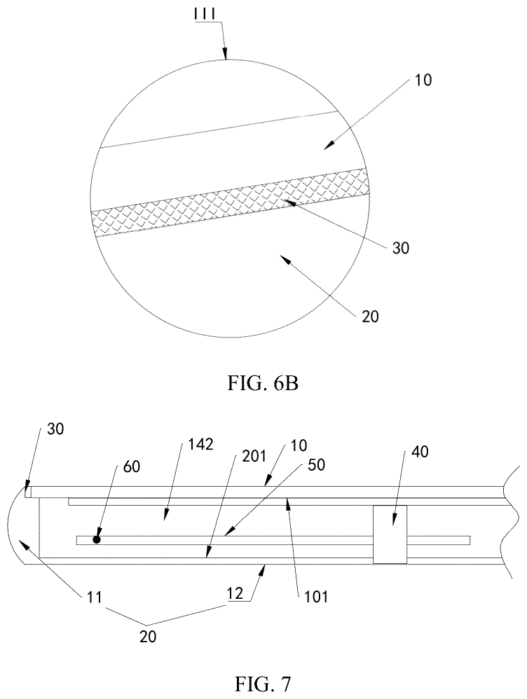

FIG. 5 is a diagram of an electronic device 01 according to an implementation. The implementation shown in FIG. 5 is the same as the implementation shown in FIG. 3 in that a housing 20 of the electronic device 01 is also an integrated metal rear cover structure. A main difference between the implementation shown in FIG. 5 and the implementation shown in FIG. 3 lies in that a display screen 10 in the implementation shown in FIG. 5 is a curved screen structure. In this implementation, an assembly gap 300 is formed between a periphery of the housing 20 and a periphery of the display screen 10, and may be positioned around the display screen 10. A slot structure 30 may be part of the assembly gap 300. FIG. 6A is a schematic enlarged view of a part II in FIG. 5, and FIG. 6B is a schematic enlarged view of a part III in FIG. 5. The slot structure 30 shown in FIG. 6A is in an area that is on a lateral edge of the electronic device 01 and that is close to the top, and the slot structure 30 shown in FIG. 6B is on a bottom edge of the electronic device 01. In this implementation, the slot structure 30 may alternatively be formed inside the housing 20. In this implementation, the electronic device 01 also includes a first conducting layer and a second conducting layer. For example, the second conducting layer is a shield layer structure of the display screen 10, and the first conducting layer is part of the housing 20.

The first conducting layer, the second conducting layer, and a conducting connection member that are inside the electronic device are connected to form a cavity, and the slot structure 30 on a surface is used as a path for magnetic interconnection between the cavity and a circuit outside the electronic device, to form an antenna element. The antenna element may be understood as a cavity-backed slot antenna, and a feed unit feeds to excite the antenna element to generate resonances.

FIG. 7 is a diagram of a cross section of an electronic device according to an implementation of this disclosure. It can be learned from FIG. 7 that an internal space of the electronic device is surrounded by a display screen 10 and a housing 20 to be formed. The housing 20 is an integrated all-metal structure, and an assembly gap is formed at a joint between the display screen 10 and the housing 20 (the assembly gap may be similar to the assembly gap 300 in the implementations shown in FIG. 3 and FIG. 5, that is, the assembly gap is a non-shielding material around the display screen 10, and a position of the assembly gap may be a path for electromagnetic wave intercommunication between an antenna inside the electronic device and the outside). In an implementation, part of the assembly gap is used as a slot structure 30 that is a path of a cavity-backed antenna inside the electronic device for electromagnetic wave communication. Therefore, the slot structure 30 is at the joint between the display screen 10 and the housing 20. The slot structure 30 may be an insulating adhesive or an insulating medium at the joint between the display screen 10 and the housing 20. The display screen 10 includes a second conducting layer 101 (for example, the second conducting layer 101 may be a shield layer of the display screen 10), and the housing 20 includes a first conducting layer 201 (for example, the first conducting layer 201 is the housing 20, and in this case, the housing 20 is of an all-metal structure). In a specific implementation, a conducting connection member 40 inside the electronic device is electrically connected between the second conducting layer 101 of the display screen 10 and the first conducting layer 201 of the housing 20, so that the second conducting layer 101, the conducting connection member 40, and the first conducting layer 201 jointly enclose a cavity 142, and the slot structure 30 is a path for electromagnetic wave interconnection between the cavity 142 and the outside of the electronic device.

In the implementation shown in FIG. 7, part of a circuit board 50 is in the cavity 142. The circuit board 50 may be a layer between the first conducting layer 201 and the second conducting layer 101; the circuit board 50 and the first conducting layer 201 may be separated by using a medium, where the medium may be air; and the circuit board 50 and the second conducting layer 101 may also be separated by using a medium. In a specific implementation, a feed unit 60 (which may be a feed port) is disposed at a position that is on the circuit board 50 and that is close to a lateral frame of the electronic device, and the lateral frame of the electronic device may be a middle frame 11 of the housing 20. A feed line is disposed on the circuit board 50, and the feed line is electrically connected between a radio frequency circuit inside the electronic device and the feed port. The radio frequency circuit inside the electronic device may be on a mainboard inside the electronic device.

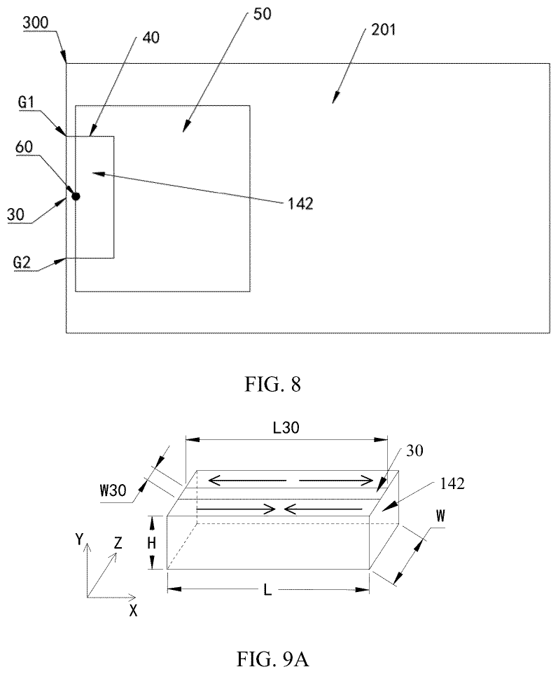

FIG. 8 is a plane diagram of an internal structure of an electronic device according to an implementation of this disclosure. FIG. 8 shows a position of a conducting connection member and a position of a circuit board inside the electronic device according to this implementation. As the conducting connection member is connected between a first conducting layer and a second conducting layer, FIG. 8 shows only a diagram of a position relationship among the first conducting layer 201, the conducting connection member 40, and the circuit board 50, and a cross section of the conducting connection member 40 in a direction parallel to a plane in which the first conducting layer 201 is located. As shown in FIG. 8, in an implementation, the outermost rectangular frame represents an assembly gap 300 at a joint between a housing and a display screen that are of the electronic device. A slot structure 30 is part of the assembly gap 300. This implementation is similar to the implementation shown in FIG. 2A. In another implementation, the slot structure 30 may alternatively be the implementation shown in FIG. 2B, FIG. 2C, or FIG. 2D. A specific position of the slot structure is not limited in this disclosure. The slot structure 30 may alternatively be any one of or a combination of the implementations shown in FIG. 3 and FIG. 5.

As shown in FIG. 8, in an implementation, positions at which two ends of the conducting connection member 40 are connected to the assembly gap 300 are two grounding positions G1 and G2 of the assembly gap, and part of the assembly gap 300 between the two grounding positions is the slot structure 30. Two ends of the slot structure 30 are the two ends of the conducting connection member 40. A space surrounded by the slot structure 30 and the conducting connection member 40 together is a cavity 142, and part of the circuit board 50 is inside the cavity 142. A feed unit 60 is disposed on the circuit board 50. In FIG. 8, a small black dot is used to represent a position of a feed port of the feed unit 60. The feed unit 60 may include the feed port, or may include a feed line, a match circuit on the feed line, and the like.

In this disclosure, the cavity 142 is constructed inside the electronic device to form an antenna element, and the antenna element is a cavity-backed antenna. In this disclosure, a length-width ratio of the cavity 142 is limited, and a length of the slot structure 30 is limited to be the same as a length of the cavity 142, to expand an operating bandwidth of the antenna element. That the lengths are the same may be understood as that the two lengths are equal, or that a difference between the two lengths is small, and a dimension error because of a design tolerance or a manufacturing tolerance is allowed. The length of the cavity 142 is a distance from one end to the other end of the cavity 142 along an extension direction of the slot structure 30, and a width of the cavity 142 is a dimension of the cavity 142 in a direction perpendicular to the extension direction of the slot structure 30 and perpendicular to a thickness direction of the electronic device 01.

In an implementation, a ratio of the length of the cavity 142 to the width of the cavity 142 inside the electronic device is greater than or equal to 3. In this implementation, by limiting the length-width ratio of the cavity 142, a cavity-backed slot antenna formed by the cavity 142 and the slot structure 30 can generate at least two operating resonances (frequency points) with excitation of one feed signal, providing a good bandwidth feature. In a specific implementation, the range of the ratio of the length of the cavity 142 to the width of the cavity 142 is greater than or equal to 3 and less than or equal to 10. As long as it is ensured that the length of the slot structure 30 is approximately the same as the length of the cavity 142, with reference to the length-width ratio of the cavity 142 ranging from greater than or equal to 3 to less than or equal to 10, in this solution, an upper limit of the length-width ratio of the cavity is provided to limit a space occupied by the cavity-backed slot antenna inside the electronic device, so that an operating bandwidth of an antenna element can be expanded in the limited space, providing high radiation performance.

In a specific implementation, when the range of the ratio of the length of the cavity to the width of the cavity is greater than or equal to 3 and less than or equal to 7, the cavity is capable of generating two or three resonance modes within 50% of a bandwidth of a lowest resonance frequency of the cavity.

In a specific implementation, when the range of the ratio of the length of the cavity to the width of the cavity is greater than 7 and less than or equal to 10, the cavity is capable of generating four or more resonance modes within 50% of a bandwidth of a lowest resonance frequency of the cavity.

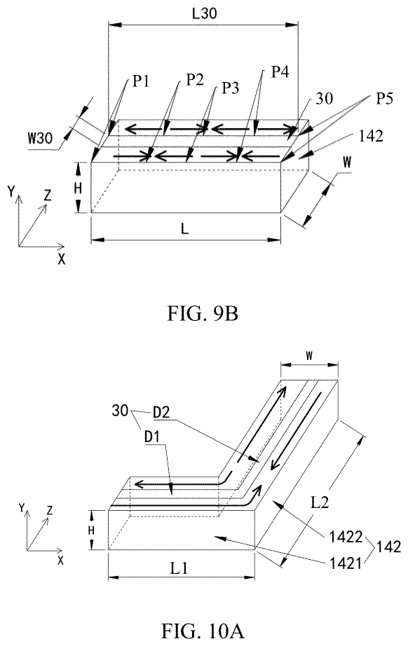

FIG. 9A and FIG. 9B show a straight bar-shaped cavity 142 provided in an implementation. The straight bar-shaped cavity 142 provided in this implementation may be used at a position on a longer edge or a position on a shorter edge of a display screen of an electronic device. FIG. 9A is a diagram of the cavity 142 and a current flow direction on the cavity 142 in a state in a first resonance mode, and FIG. 9B is a diagram of the cavity 142 and a current flow direction on the cavity 142 in a state in a second resonance mode. As shown in FIG. 9A and FIG. 9B, a length L of the cavity 142 is a dimension of the cavity 142 extending in a first direction X, a width W of the cavity 142 is a dimension of the cavity 142 extending in a second direction Z, and a height H of the cavity is a height of the cavity 142 extending in a third direction Y. In a specific electronic device, the first direction X may be a direction of the longer edge or a direction of a shorter edge of the display screen of the electronic device, the second direction Z may be a direction from an edge of the display screen toward the inside of the display screen vertically, and the third direction Y may be a thickness direction of the electronic device. The third direction Y may also be understood as a direction indicated by a vertical line connecting a first conducting layer and a second conducting layer. In an implementation, a length of a slot structure 30 is the same as the length L of the cavity 142. In the implementations shown in FIG. 9A and FIG. 9B, a value range of a length-width ratio of the cavity 142 is 3≤L/W≤12. As shown in FIG. 9A, the cavity 142 is at a first resonance frequency, and a current flows from two ends of the slot structure 30 to the middle of the slot structure along one edge position of the slot structure 30, and a current flows from a middle position of the slot structure 30 to the two ends of the slot structure along another edge position of the slot structure 30. As shown in FIG. 9B, two edges of the slot structure 30 each include a first end P1, a first quarter position P2, a middle position P3, a second quarter position P4, and a second end P5. The cavity 142 is at a second resonance frequency. Along one edge position of the slot structure 30, a current flows from the first quarter position P2 toward two sides to the first end P1 and the middle position P3 respectively, and a current flows from the second quarter position P4 toward two sides to the middle position P3 and the second end P5 respectively. Along another edge position of the slot structure 30, a current flows from the first end P1 to the first quarter position P2, a current flows from the middle position P3 toward two sides to the first quarter position P2 and the second quarter position P4 respectively, and a current flows from the second end P5 to the second quarter position P4.

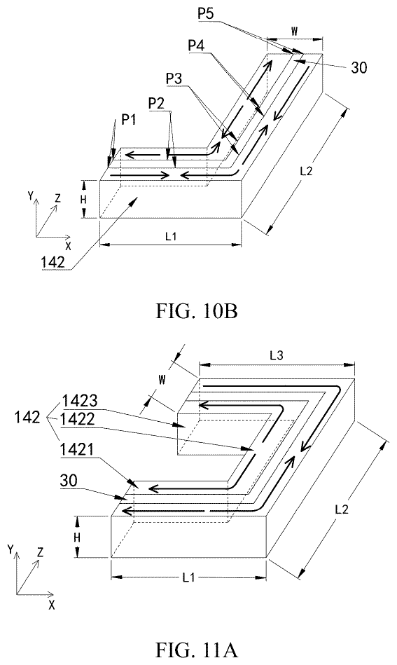

FIG. 10A and FIG. 10B show a cavity 142 in a bent form (for example, an L shape or a C shape) according to an implementation. The cavity 142 in the bent form according to this implementation may be used at a position at which a longer edge and a shorter edge of a display screen of an electronic device intersect. FIG. 10A is a diagram of the cavity 142 and a current flow direction on the cavity 142 in a state in a first resonance mode, and FIG. 10B is a diagram of the cavity 142 and a current flow direction on the cavity 142 in a state in a second resonance mode. In an implementation, as shown in FIG. 10A and FIG. 10B, the cavity 142 includes a first cavity 1421 and a second cavity 1422. The first cavity 1421 extends in a first direction X, and the second cavity 1422 extends in a second direction Z. The first cavity 1421 and the second cavity 1422 are interconnected to form an L-shaped cavity architecture. A slot structure 30 includes a first segment D1 and a second segment D2. The first segment D1 extends in the first direction X, and the second segment D2 extends in the second direction Z. A length of the cavity 142 is a sum of a dimension L1 of the first cavity 1421 extending in the first direction X and a dimension L2 of the second cavity 1422 extending in the second direction Z, that is, L1+L2. A width W of the cavity 142 is a dimension of the first cavity 1421 in the second direction Z or a dimension of the second cavity 1422 in the first direction X. The dimension of the first cavity 1421 in the second direction Z may be equal to or may not be equal to the dimension of the second cavity 1422 in the first direction X. When the dimension of the first cavity 1421 in the second direction Z is not equal to the dimension of the second cavity 1422 in the first direction X, the width W of the cavity 142 is a larger one of the dimension of the first cavity 1421 in the second direction Z and the dimension of the second cavity 1422 in the first direction X. A height H of the cavity 142 is a dimension of the first cavity 1421 in a third direction Y or a dimension of the second cavity 1422 in a third direction Y. In an implementation, the dimension of the first cavity 1421 in the third direction Y is the same as the dimension of the second cavity 1422 in the third direction Y. In an implementation, the dimension of the first cavity 1421 in the third direction Y is not equal to the dimension of the second cavity 1422 in the third direction Y. In this case, the height H of the cavity 142 is a larger one of the dimension of the first cavity 1421 in the third direction Y and the dimension of the second cavity 1422 in the third direction Y. As shown in FIG. 10A, two edges of the slot structure 30 are L-shaped. The cavity 142 is at a first resonance frequency, and a current flows from two ends of the slot structure 30 to the middle of the slot structure along one edge position of the slot structure 30, and a current flows from a middle position of the slot structure to the two ends of the slot structure 30 along another edge position of the slot structure. As shown in FIG. 10B, two edges of the slot structure 30 each include a first end P1, a first quarter position P2, a middle position P3, a second quarter position P4, and a second end P5. The cavity 142 is at a second resonance frequency. Along one edge position of the slot structure 30, a current flows from the first quarter position P2 toward two sides to the first end P1 and the middle position P3 respectively, and a current flows from the second quarter position P4 toward two sides to the middle position P3 and the second end P5 respectively. Along another edge position of the slot structure 30, a current flows from the first end P1 to the first quarter position P2, a current flows from the middle position P3 toward two sides to the first quarter position P2 and the second quarter position P4 respectively, and a current flows from the second end P5 to the second quarter position P4.

FIG. 11A and FIG. 11B show a cavity 142 according to an implementation. The cavity 142 is bent and half-encircling. For example, the cavity 142 is a U-shaped architecture. The cavity 142 according to this implementation may be used on the top or the bottom of a display screen of an electronic device. For example, on the top of the display screen, part of the cavity corresponds to a part of one longer edge that is of the display screen and that is adjacent to a top edge. Part of the cavity corresponds to a shorter edge of the entire display screen, and part of the cavity corresponds to a part of the other longer edge that is of the display screen and that is adjacent to the top edge. FIG. 11A is a diagram of the cavity 142 and a current flow direction on the cavity 142 in a state in a first resonance mode, and FIG. 11B is a diagram of the cavity 142 and a current flow direction on the cavity 142 in a state in a second resonance mode. As shown in FIG. 11A and FIG. 11B, the cavity 142 includes a first cavity 1421, a second cavity 1422, and a third cavity 1423 sequentially connected. The first cavity 1421 and the third cavity 1423 both extend in a first direction X and are opposite and spaced from each other. The second cavity 1422 extends in a second direction Z and is connected between the first cavity 1421 and the third cavity 1423. A length of the cavity 142 is a sum of a dimension L1 of the first cavity 1421 in the first direction X, a dimension L2 of the second cavity 1422 in the second direction Z, and a dimension L3 of the third cavity 1423 in the first direction X, that is, L1+L2+L3. A width W of the cavity 142 is a dimension of the first cavity 1421 in the second direction Z. When the dimension of the first cavity 1421 in the second direction Z is equal to a dimension of the third cavity 1423 in the second direction Z, the width W of the cavity 142 may alternatively be the dimension of the third cavity 1423 in the second direction Z. When the dimension of the first cavity 1421 in the second direction Z is not equal to the dimension of the third cavity 1423 in the second direction Z, the width W of the cavity 142 is a larger one of the dimension of the first cavity 1421 in the second direction Z and the dimension of the third cavity 1423 in the second direction Z. A height H of the cavity 142 is a dimension of the first cavity 1421 in a third direction Y, a dimension of the second cavity 1422 in a third direction Y, or a dimension of the third cavity 1423 in a third direction Y. In an implementation, the dimension of the first cavity 1421 in the third direction Y, the dimension of the second cavity 1422 in the third direction Y, and the dimension of the third cavity 1423 in the third direction Y are all equal. In an implementation, the dimension of the first cavity 1421 in the third direction Y, the dimension of the second cavity 1422 in the third direction Y, and the dimension of the third cavity 1423 in the third direction Y are unequal. In this case, the height H of the cavity 142 is the largest among the dimension of the first cavity 1421 in the third direction Y, the dimension of the second cavity 1422 in the third direction Y, and the dimension of the third cavity 1423 in the third direction Y. As shown in FIG. 11A, two edges of the slot structure 30 are U-shaped. The cavity 142 is at a first resonance frequency, and a current flows from two ends of the slot structure 30 to the middle of the slot structure 30 along one edge position of the slot structure 30, and a current flows from a middle position of the slot structure 30 to the two ends of the slot structure 30 along another edge position of the slot structure 30. As shown in FIG. 11B, current distribution at the two edges of the slot structure 30 is similar to current distribution directions shown in FIG. 9B and FIG. 10B. Details are not described again.

The cavity 142 according to the implementation shown in FIG. 9A, FIG. 10A, or FIG. 11A works at a first resonance frequency F1, and the cavity 142 according to the implementation shown in FIG. 9B, FIG. 10B, or FIG. 11B works at a second resonance frequency F2. In an implementation, a relationship between the first resonance frequency F1 and the second resonance frequency F2 is 1<F2/F1<1.3. In an implementation, by limiting a length-width ratio of the cavity to a small range (for example, the length-width ratio of the cavity is greater than or equal to 3 and less than or equal to 7), the cavity 142 can generate two resonance points within an operating band range, and a bandwidth can be expanded with an appropriate dimension range. In other words, a bandwidth requirement is ensured while a dimension range of the cavity 142 is properly controlled, and antenna performance is ensured.

In an implementation, the cavity can generate three resonances. To be specific, the cavity works at a first resonance frequency F1, a second resonance frequency F2, and a third resonance frequency F3, and a relationship among the first resonance frequency F1, the second resonance frequency F2, and the third resonance frequency F3 is 1<F2/F1<1.25<F3/F1<1.5. In this solution, the relationship among the three resonance frequencies generated by a cavity-backed slot antenna is limited, that is, a specific antenna architecture is defined, to ensure that radiation performance at all the three resonance frequencies satisfies a requirement.

In an implementation, for an antenna element formed by a cavity and a slot structure, a minimum length of the cavity is a ½ operating wavelength λ of the antenna element in a resonance at an operating frequency, a maximum width of the cavity is the ½ operating wavelength λ of the antenna element in the resonance of the operating frequency, and a height of the cavity is less than a 1/12 operating wavelength λ of the antenna in the resonance at the operating frequency.

In an implementation, a range of a ratio of the length of the cavity to the width of the cavity is greater than or equal to 4 and less than or equal to 6. In this solution, a balance between dimensions and radiation performance can be achieved, and radiation performance of the antenna element is improved with an appropriate dimension range. On one hand, a space can be saved; on the other hand, it is ensured that the cavity can generate two or three resonance modes.

In an implementation, a dimension of the cavity is greater than or equal to 1 mm in a thickness direction of the electronic device. In this solution, the dimension of the cavity in the thickness direction is limited to ensure radiation performance of the cavity-backed slot antenna. In the limited space, a larger dimension of the cavity in the thickness direction indicates higher radiation performance. However, to ensure a design requirement for miniaturization of the electronic device, the dimension of the cavity is limited to be greater than or equal to 1 mm. In other words, both a radiation performance requirement of an antenna and the space design requirement of the electronic device can be satisfied.

In an implementation, an operating band of the cavity includes 2.4 GHz, a dimension range of the length of the cavity is greater than or equal to 75 mm and less than or equal to 150 mm, and a dimension range of the width of the cavity is greater than or equal to 15 mm and less than or equal to 30 mm. In this solution, the length range and the width range of the cavity are limited, so that the cavity-backed slot antenna that works in the operating band of 2.4 GHz can be defined.

In an implementation, an operating band of the cavity includes 5 GHz, a dimension range of the length of the cavity is greater than or equal to 36 mm and less than or equal to 72 mm, and a dimension range of the width of the cavity is greater than or equal to 7.2 mm and less than or equal to 14.4. In this solution, the length range and the width range of the cavity are limited, so that the cavity-backed slot antenna that works in the operating band of 5 GHz can be defined.

In an implementation, the operating band of the cavity includes 2.4 GHz, the dimension range of the length of the cavity is greater than or equal to 75 mm and less than or equal to 100 mm, and the dimension range of the width of the cavity is greater than or equal to 15 mm and less than or equal to 25 mm. In this solution, the length range and the width range of the cavity are limited. Compared with the foregoing implementation, this solution provides a more specific range limit and is also intended to define the cavity-backed slot antenna that works in the operating band of 2.4 GHz.

In an implementation, the operating band of the cavity includes 5 GHz, the dimension range of the length of the cavity is greater than or equal to 36 mm and less than or equal to 48 mm, and the dimension range of the width of the cavity is greater than or equal to 7.2 mm and less than or equal to 12 mm. In this solution, the length range and the width range of the cavity are limited. Compared with the foregoing implementation, this solution provides a more specific range limit and is also intended to define the cavity-backed slot antenna that works in the operating band of 5 GHz.

In the implementations shown in FIG. 3 and FIG. 5, the housing 20 of the electronic device 01 is an integrated metal rear cover structure, and the periphery of the housing 20 and the periphery of the display screen 10 are joined to form the enclosed assembly gap 300 surrounding the display screen. A position of the assembly gap 300 may be disposed with an adhesive structure or the like, and the slot structure 30 connected to the cavity is part of the assembly gap 300. In this solution, the assembly gap 300 between the display screen 10 and the all-metal rear cover (the housing 20) forms the slot structure 30 of the cavity-backed antenna slot, so that a function of the assembly gap 300 is extended, and design costs are reduced. No additional slot structure needs to be provided on the housing 20 of the electronic device 01, so that integrality of the all-metal rear cover of the electronic device can be ensured, and manufacturing process costs can be reduced. Not only user experience and appearance integrality of the electronic device 01 can be ensured, but the radiation performance of the cavity-backed slot antenna can also be achieved.

With reference to FIG. 9A and FIG. 9B, in this implementation, a width W30 of the slot structure 30 is greater than or equal to 0.7 mm. In this solution, a lower limit of the width of the slot structure is provided to ensure the radiation performance of the cavity-backed slot antenna. For the cavity-backed slot antenna, a larger width of the slot structure indicates higher radiation performance. In a specific implementation, the width W30 of the slot structure 30 is 1.5 mm. In this solution, a specific value of the slot structure is limited to 1.5 mm. For the assembly gap, because the dimension is limited to 1.5 mm, a requirement for assembling the display screen and the housing can be satisfied, and the cavity-backed slot antenna can have high radiation performance. The width W30 of the slot structure 30 is a dimension in a direction perpendicular to a length direction of the slot structure 30, or may be understood as a vertical distance between the periphery of the housing and the periphery of the display screen. In this solution, a width range of the slot structure 30 is limited, so that when the housing 20 and the display screen 10 that are of the electronic device are normally connected, part of the assembly gap between the housing and the display screen has a function of the slot structure 30 of an antenna element, to ensure radiation efficiency of the antenna element.

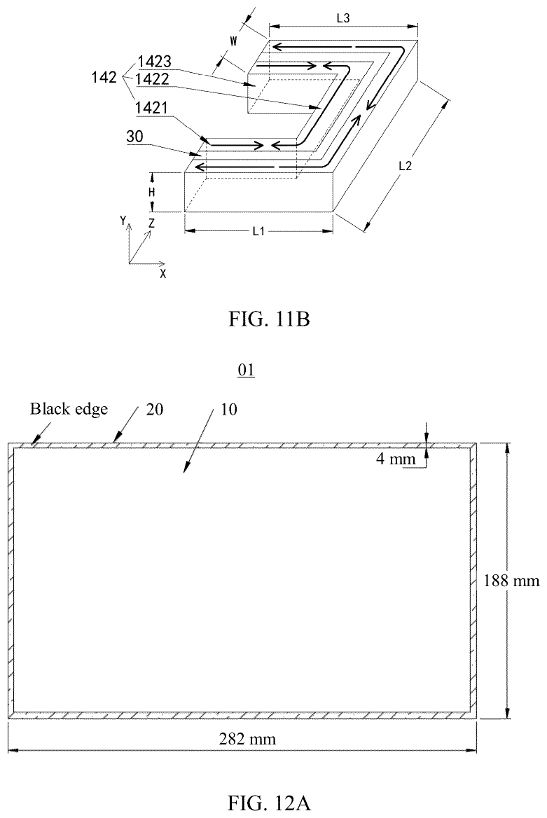

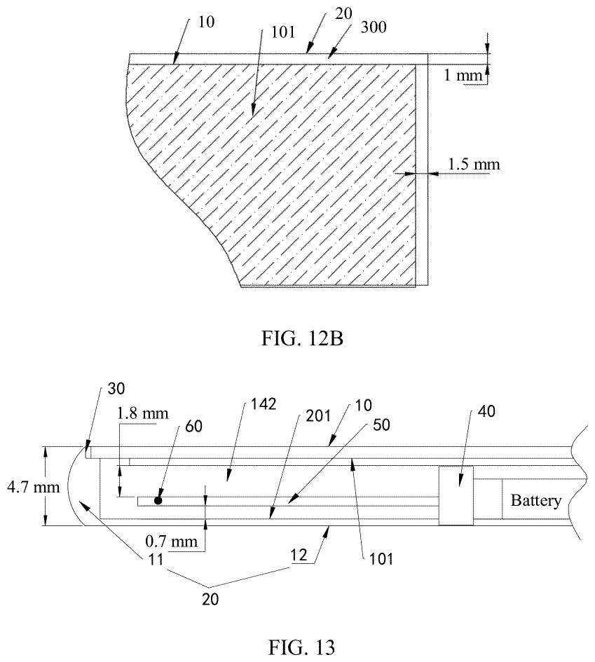

As shown in FIG. 12A, in an implementation, an overall length of an electronic device 01 is 282 mm, and an approximate overall width of the electronic device 01 is 188 mm. In this implementation, a width of a black edge between a periphery of a display area of a display screen 10 and a periphery of a housing 20 may be 4 mm. FIG. 12B is a diagram of a width of an assembly gap 300 between a periphery of a second conducting layer 101 of the display screen 10 and the periphery of the housing 20 in the implementation of FIG. 12A. The width of the assembly gap 300 may be 1 mm or 1.5 mm. For example, a width of the assembly gap 300 at a position on a shorter edge of the display screen 10 is 1.5 mm, and a width of the assembly gap 300 at a position on a longer edge of the display screen 10 is 1 mm. A position of the assembly gap 300 may be filled with an insulating medium, for example, polycarbonate and acrylonitrile butadiene styrene (PC-ABS). ER-3, where ER represents a relative dielectric constant of the filling medium, and LT=0.01, where LT (loss tangent) means a loss tangent of the medium.

Refer to FIG. 13. In an implementation, a total thickness of an electronic device 01 is 4.7 mm. In a cavity 142, a vertical distance between a circuit board 50 and a second conducting layer 101 is 1.8 mm, and a vertical distance between the circuit board 50 and a first conducting layer 201 is 0.7 mm. In this implementation, a conducting connection member 40 is part of a battery compartment, or the conducting connection member 40 is connected to the battery compartment. The battery compartment is a structure for accommodating a battery, the battery compartment is a metal frame structure, and the conducting connection member 40 and the battery compartment may be an integrated one-piece architecture.

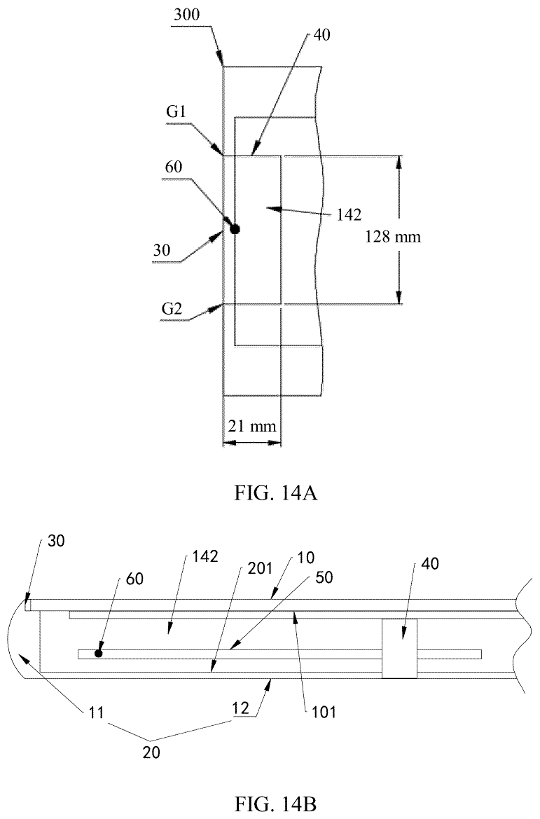

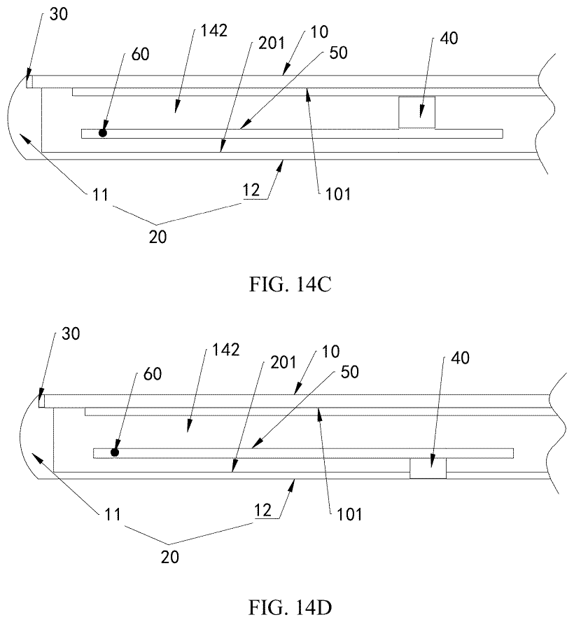

Refer to FIG. 14A. In an implementation, a length of a cavity 142 is 128 mm, and a width of the cavity 142 is 21 mm. FIG. 14B shows an implementation in which two ends of a conducting connection member 40 are electrically connected to a first conducting layer 201 and a second conducting layer 101 respectively. FIG. 14C shows an implementation in which two ends of a conducting connection member 40 are electrically connected to a second conducting layer 101 and a circuit board 50 respectively. FIG. 14D shows an implementation in which two ends of a conducting connection member 40 are electrically connected to a first conducting layer 201 and a circuit board 50 respectively.

When the two ends of the conducting connection member 40 are electrically connected to the first conducting layer 201 and the second conducting layer 101 respectively, a height of the cavity 142 reaches a maximum value. This implementation is applied to a Wi-Fi antenna, and electromagnetic wave signal radiation performance of the cavity satisfies a requirement.

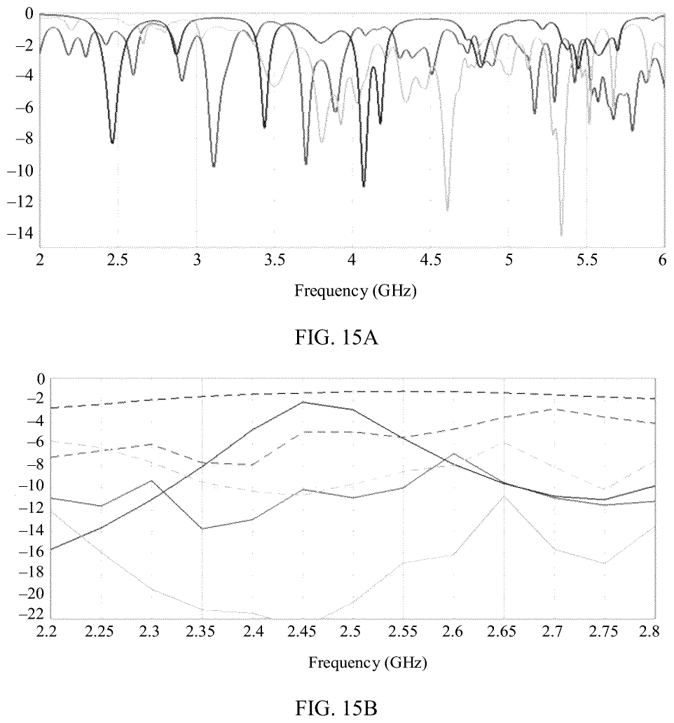

FIG. 15A is a diagram of comparison between S11 parameter distribution diagrams in the implementations shown in FIG. 14B, FIG. 14C, and FIG. 14D. FIG. 15B is a diagram of comparison between antenna radiation efficiency in the implementations shown in FIG. 14B, FIG. 14C, and FIG. 14D.

Refer to the curve diagrams shown in FIG. 15A and FIG. 15B. The implementation shown in FIG. 14B can be seen, that is, a conducting connection member is connected between a first conducting layer and a second conducting layer, providing high radiation efficiency, and performance of a Wi-Fi antenna can satisfy a requirement.

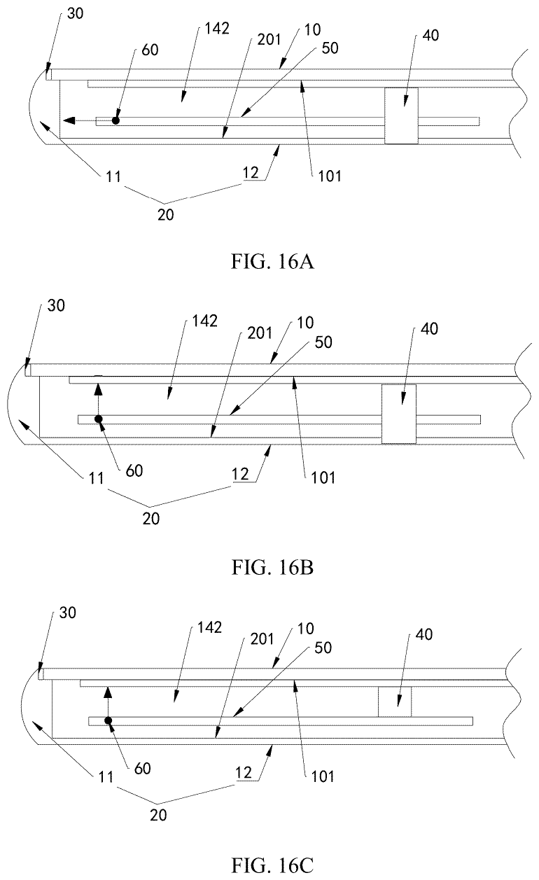

FIG. 16A, FIG. 16B, and FIG. 16C show feeding solutions in three specific implementations. In the implementation shown in FIG. 16A, two ends of a conducting connection member 40 are electrically connected to a first conducting layer 201 and a second conducting layer 101 respectively, and a feed unit 60 feeds toward a middle frame 11 (that is, a lateral frame of an electronic device) of the housing 20. A position between the feed unit 60 and the middle frame 11 is equivalent to a serial capacitor with a capacitance value of 1.5 pF. In the implementation shown in FIG. 16B, two ends of the conducting connection member 40 are electrically connected to the first conducting layer 201 and the second conducting layer 101 respectively, and the feed unit 60 feeds toward the second conducting layer 101. A position between the feed unit 60 and the second conducting layer 101 of a display screen 10 is equivalent to a serial capacitor with a capacitance value of 1.5 pF. In the implementation shown in FIG. 16C, two ends of the conducting connection member 40 are electrically connected to a circuit board 50 and the second conducting layer 101 respectively, and the feed unit 60 feeds toward the second conducting layer 101. A position between the feed unit 60 and the second conducting layer 101 of the display screen 10 is equivalent to a serial capacitor with a capacitance value of 1.5 pF.

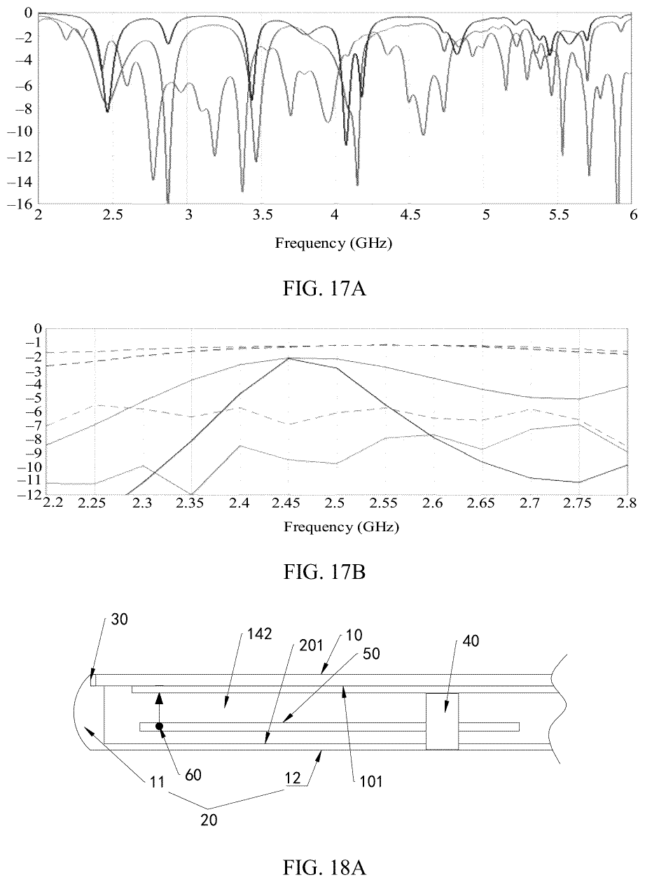

FIG. 17A is a diagram of comparison between S11 parameter distribution diagrams in the implementations shown in FIG. 16A, FIG. 16B, and FIG. 16C. FIG. 17B is a diagram of comparison between antenna radiation efficiency in the implementations shown in FIG. 16A, FIG. 16B, and FIG. 16C.

Refer to the curve diagrams shown in FIG. 17A and FIG. 17B. The implementations shown in FIG. 16A and FIG. 16B can be seen, that is, a conducting connection member is connected between a first conducting layer and a second conducting layer, and a feed unit 60 feeds toward a middle frame or the second conducting layer that is relatively far away, providing high radiation efficiency and ensuring a bandwidth of an antenna element, and performance of a Wi-Fi antenna can satisfy a requirement. Compared with that in the implementation shown in FIG. 16C, bandwidth efficiency in the implementation shown in FIG. 16B may be tripled, and in-band efficiency at Wi-Fi 2.4 GHz reaches −3 dB.

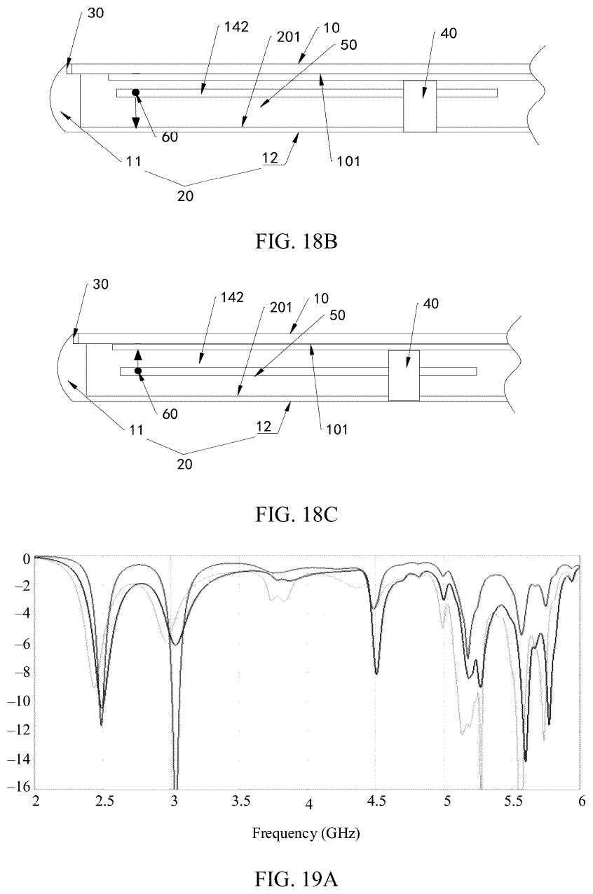

In three specific implementations provided in FIG. 18A, FIG. 18B, and FIG. 18C, based on a solution in which a conducting connection member is connected between a first conducting layer and a second conducting layer, a specific position of a circuit board is designed differently. The circuit board at different positions feeds the first conducting layer or the second conducting layer that is relatively far away, so that radiation efficiency of a cavity satisfies a requirement, and a bandwidth is ensured. As shown in FIG. 18A, in an implementation, a distance between a circuit board 50 and a first conducting layer 201 is less than a distance between the circuit board 50 and a second conducting layer 101. For example, the distance between the circuit board 50 and the first conducting layer 201 is 0.7 mm, the distance between the circuit board 50 and the second conducting layer 101 is 1.8 mm, and a feed unit 60 feeds toward the second conducting layer 101. In this way, radiation efficiency of the cavity and the bandwidth can be ensured. As shown in FIG. 18B, in an implementation, the distance between the circuit board 50 and the first conducting layer 201 is greater than the distance between the circuit board 50 and the second conducting layer 101. For example, the distance between the circuit board 50 and the first conducting layer 201 is 1.8 mm, the distance between the circuit board 50 and the second conducting layer 101 is 0.7 mm, and the feed unit 60 feeds toward the first conducting layer 201. In this way, radiation efficiency of the cavity and the bandwidth can be ensured. As shown in FIG. 18C, the circuit board 50 is at a middle position. In other words, the circuit board 50 is close to the first conducting layer 201 and the second conducting layer 101. For example, the distance between the circuit board 50 and the first conducting layer 201 is 1.2 mm, and the distance between the circuit board 50 and the second conducting layer 101 is 1.3 mm. In this implementation, the feed unit 60 feeds toward the second conducting layer 101. In this way, radiation efficiency of the cavity and the bandwidth can be ensured.

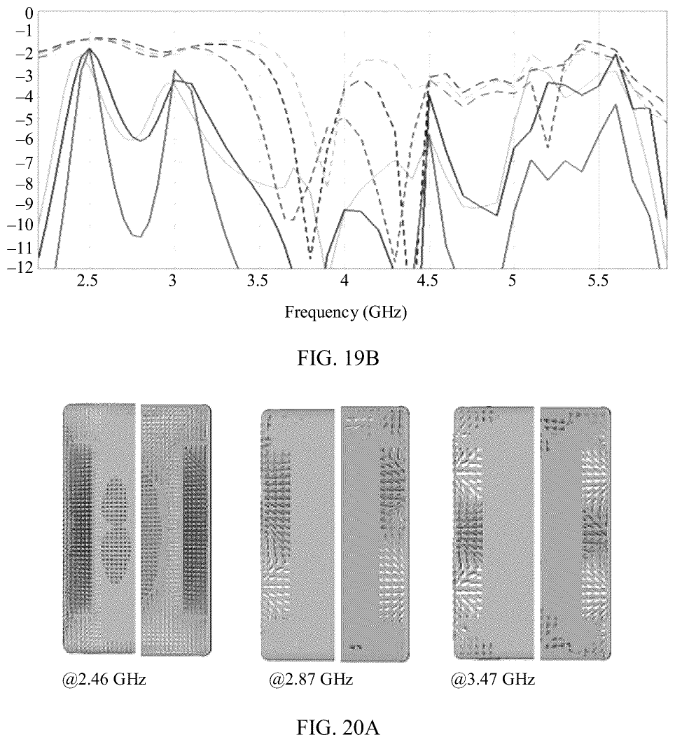

FIG. 19A is a diagram of comparison between S11 parameter distribution diagrams in the implementations shown in FIG. 18A, FIG. 18B, and FIG. 18C. FIG. 19B is a diagram of comparison between antenna radiation efficiency in the implementations shown in FIG. 18A, FIG. 18B, and FIG. 18C. Refer to the curve diagrams shown in FIG. 19A and FIG. 19B. In a cavity, when a feed unit feeds toward the farther one of a first conducting layer and a second conducting layer, radiation efficiency of an antenna and a bandwidth can be ensured. A larger distance between the feed unit and a conducting layer (the first conducting layer or the second conducting layer) on an inner wall of the cavity indicates higher radiation efficiency of the antenna and a larger bandwidth.

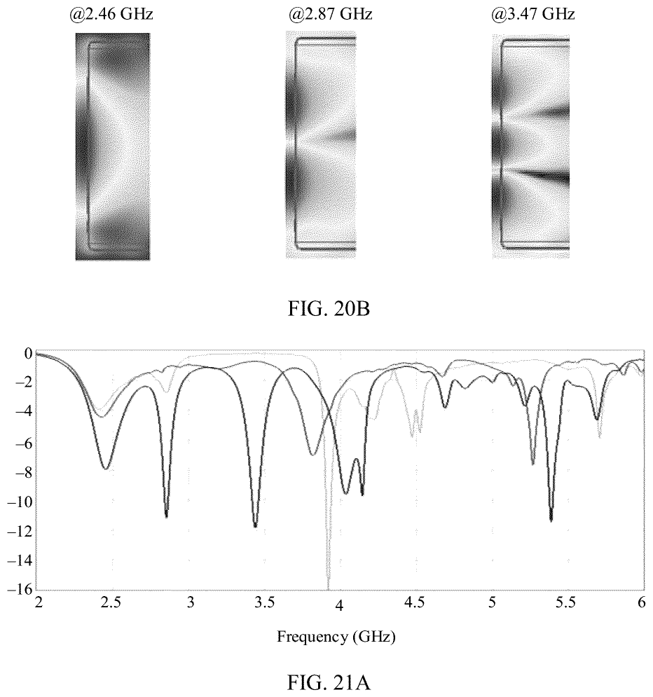

Refer to FIG. 20A and FIG. 20B. In an implementation, an antenna element formed by a cavity and a slot structure can generate three resonances in an operating band. The three resonances are 2.46 GHz, 2.87 GHZ, and 3.47 GHz respectively. FIG. 20A is a diagram of current distribution in three resonance modes, and FIG. 20B is a diagram of electric field distribution in the three resonance modes.

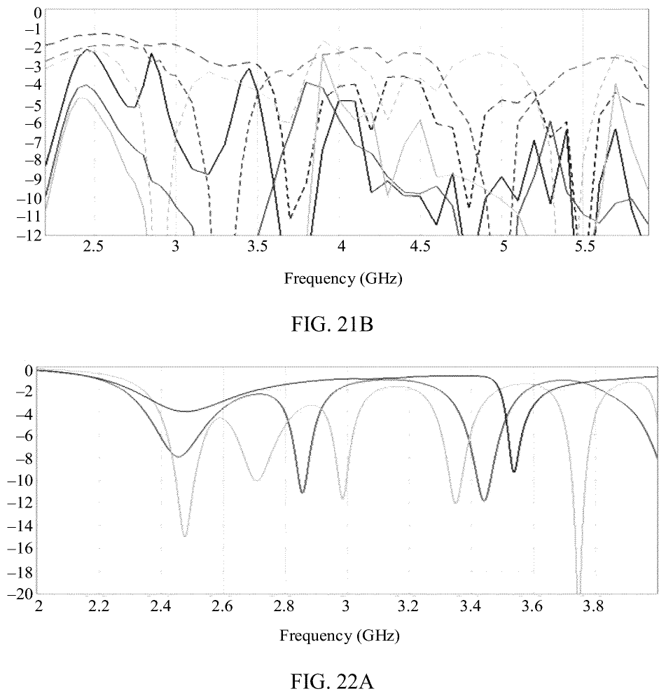

FIG. 21A is a diagram of comparison between S11 parameter distribution diagrams of three antenna elements formed by cavities with different length-width ratios. FIG. 21B is a diagram of comparison between antenna radiation efficiency of the three antenna elements formed by the cavities with different length-width ratios. A cavity provided in solution 1 has a length of 96 mm and a width of 23 mm; a cavity provided in solution 2 has a length of 66 mm and a width of 30 mm; and a cavity provided in solution 3 has a length of 56 mm and a width of 69 mm. As shown in FIG. 21A and FIG. 21B, it can be learned that, as a length and a width of a cavity increase, antenna radiation efficiency and a bandwidth can be improved. For a low-profile cavity-backed antenna, a lower limit of a length-width ratio of a cavity is about 1. When the length-width ratio is within a range of 1 to 2, impact of a length of the cavity on radiation efficiency is greater than impact of a width of the cavity on radiation efficiency, and an increase of the width of the cavity has a small effect on a fundamental mode. When the length-width ratio is greater than 3 (for example, in solution 1), radiation efficiency in the fundamental mode is significantly improved.

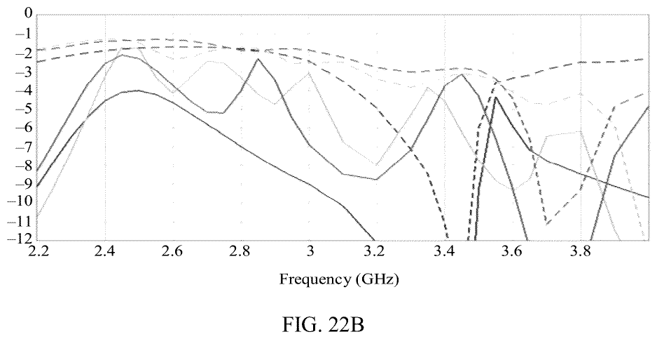

FIG. 22A is a diagram of comparison between S11 parameter distribution diagrams of three antenna elements formed by cavities with different length-width ratios. FIG. 22B is a diagram of comparison between antenna radiation efficiency of the three antenna elements formed by the cavities with different length-width ratios. A cavity provided in solution 1 has a length of 62 mm and a width of 28 mm; a cavity provided in solution 2 has a length of 132 mm and a width of 21 mm; and a cavity provided in solution 3 has a length of 192 mm and a width of 18 mm. As shown in FIG. 22A and FIG. 22B, it can be learned that, as a length and a width of a cavity increase, there are more resonance modes of an antenna element and more resonance frequency points, and antenna radiation efficiency and a bandwidth can be improved.

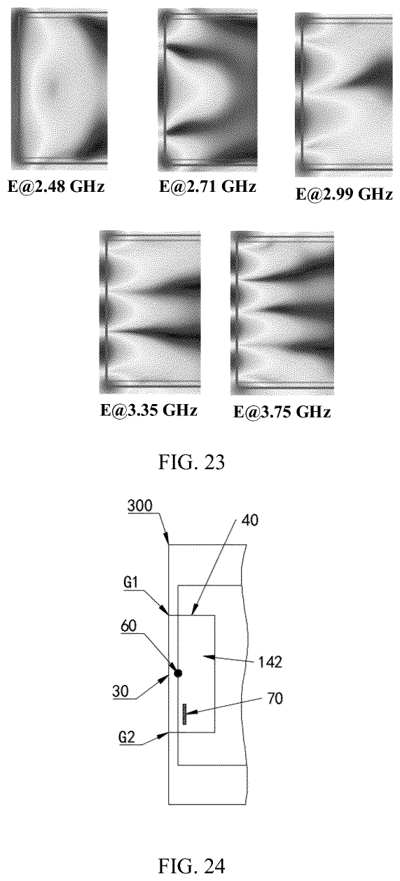

FIG. 23 is a diagram of electric field distribution in five resonance modes that can be generated by an antenna element according to an implementation. In this implementation, a cavity has a length of 192 mm and a width of 18 mm. Frequencies in the five resonance modes are 2.48 GHz, 2.71 GHz, 2.99 GHz, 3.35 GHz, and 3.75 GHz respectively.

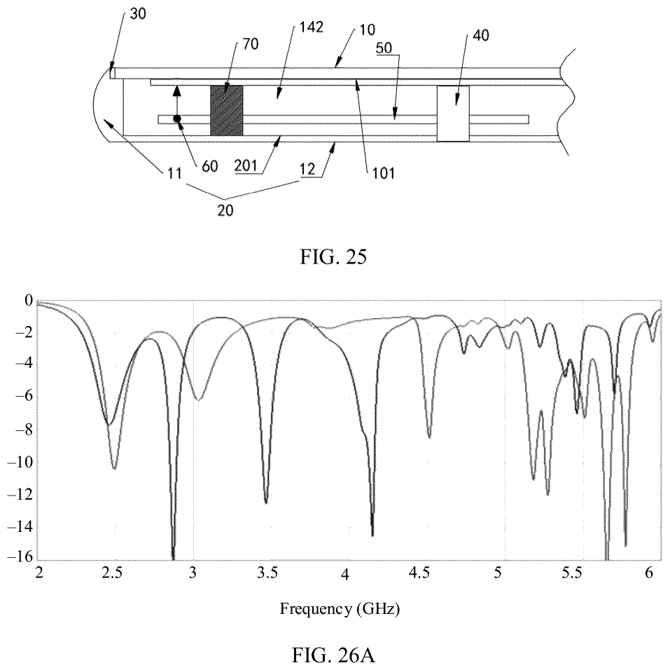

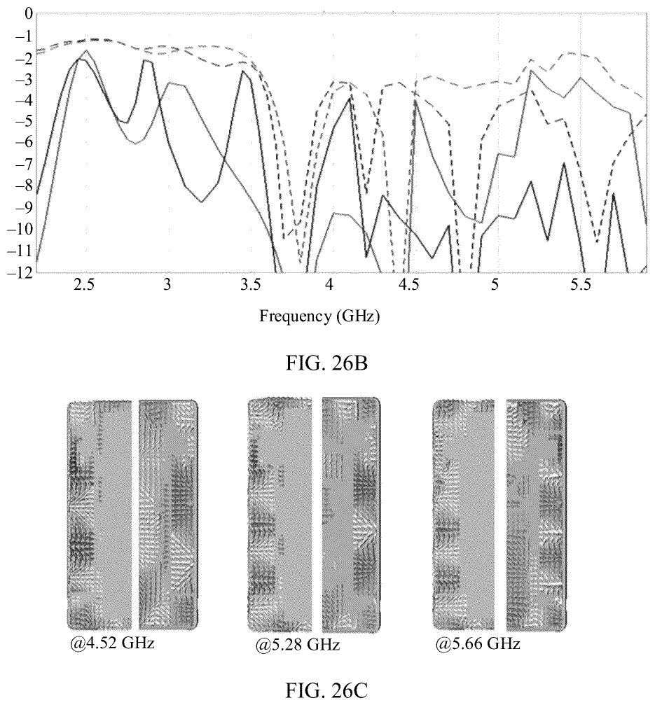

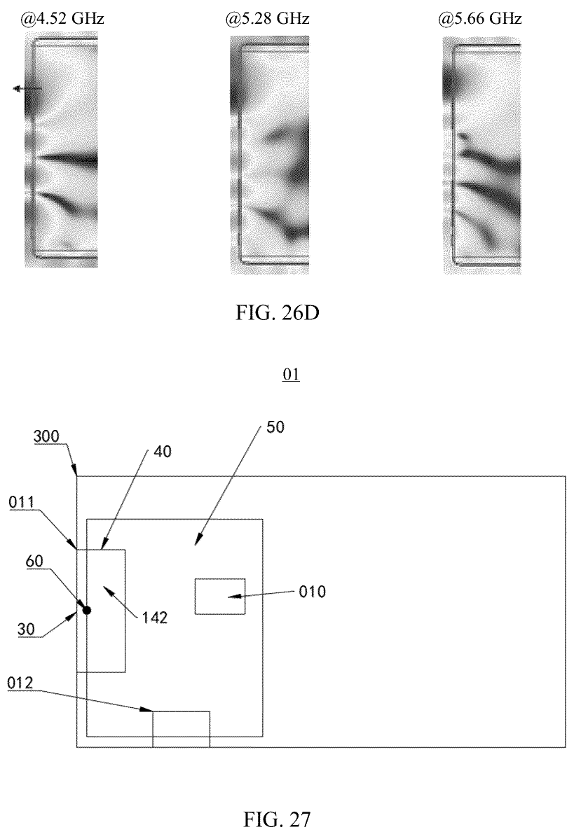

Refer to FIG. 24 and FIG. 25. In an implementation, a connection member 70 is disposed inside a cavity 142, the connection member 70 includes a conductive material and two ends of the connection member 70 are connected to a first conducting layer 201 and a second conducting layer 101 respectively, and a distance between the connection member 70 and one end of the cavity 142 is less than or equal to 0.25 times the length of the cavity 142 in a length direction of the cavity 142. In the implementation shown in FIG. 24 and FIG. 25, a length of the connection member 70 is 20 mm, a length direction of the connection member is the same as the length direction of the cavity, a distance between the connection member and a middle frame 11 of a housing 20 is 8 mm, and a shortest distance between the connection member and a metal connection member is 4 mm. FIG. 26A is a diagram of comparison between S11 parameter distribution diagrams of antenna elements according to two specific implementations (that is, a solution in which no connection member is disposed and a solution in which a connection member is disposed). FIG. 26B is a diagram of comparison between antenna radiation efficiency of antenna elements according to two specific implementations (that is, a solution in which no connection member is disposed and a solution in which a connection member is disposed). It can be learned from FIG. 26A and FIG. 26B that, in this solution, the connection member is disposed inside a cavity, so that low-frequency performance can be maintained, and high-frequency performance can be optimized. The connection member may be a conductive structure, for example, a metal column or a metal elastic sheet.

In an implementation, an operating frequency of the cavity includes a first frequency and a second frequency, the second frequency is higher than the first frequency, and the connection member does not affect radiation performance at the first frequency, and is capable of optimizing radiation performance at the second frequency.

Refer to FIG. 26C and FIG. 26D. In an implementation, the cavity with the connection member 70 shown in FIG. 24 and FIG. 25 can generate three resonance modes. The three resonance modes are 4.52 GHz, 5.28 GHz, and 5.66 GHz respectively. The cavity provided in this implementation generates a high frequency. A higher frequency indicates more obvious electric field distribution, and there is obvious electric field distribution on a periphery of a metal rear cover (that is, a housing) of an electronic device. FIG. 26A is a diagram of current distribution in three resonance modes, and FIG. 26B is a diagram of electric field distribution in the three resonance modes. It can be seen from FIG. 26A and FIG. 26B that a position of the connection member 70 has a weak current and a strong electric field.

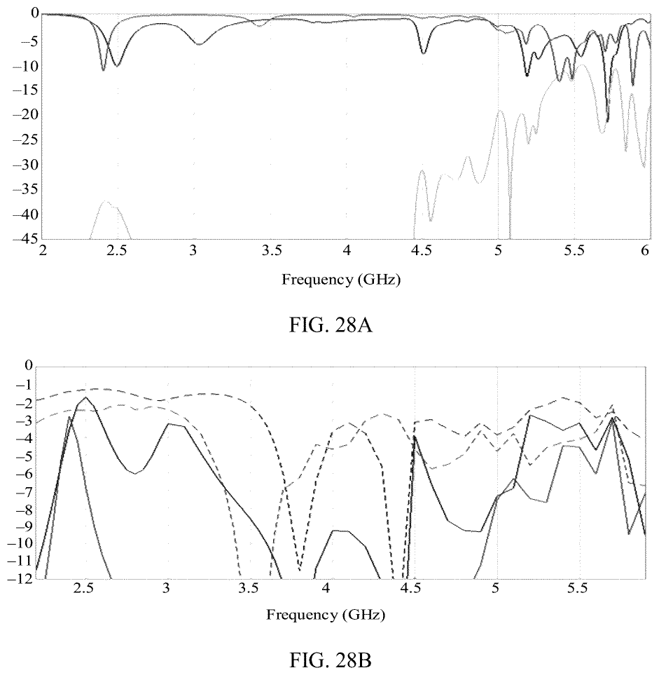

In an implementation, at least two antenna elements are disposed inside an electronic device provided in this application. Each antenna element is formed by a cavity and a slot structure, and length-width ratios of cavities in different antenna elements may be different. Refer to FIG. 27. In an implementation, a length-width ratio of a cavity of a first antenna element 11 inside an electronic device is greater than 3. For example, a length of the cavity is 128 mm, and a width of the cavity is 21 mm. There is another antenna element inside the electronic device, and a length-width ratio of a cavity of the second antenna element 12 is less than 2. For example, a length of the cavity is 54 mm, and a width of the cavity is 36 mm. Refer to FIG. 28A and FIG. 28B. FIG. 28A is a diagram of comparison between S11 parameter distribution diagrams of the two antenna elements in FIG. 27. FIG. 28B is a diagram of comparison between antenna radiation efficiency of the two antenna elements in FIG. 27. Such two antenna elements are largely different in performance, and may cover different operating bands. For example, different antenna element combinations may cover Wi-Fi 2.4 GHz and Wi-Fi 5 GHz.

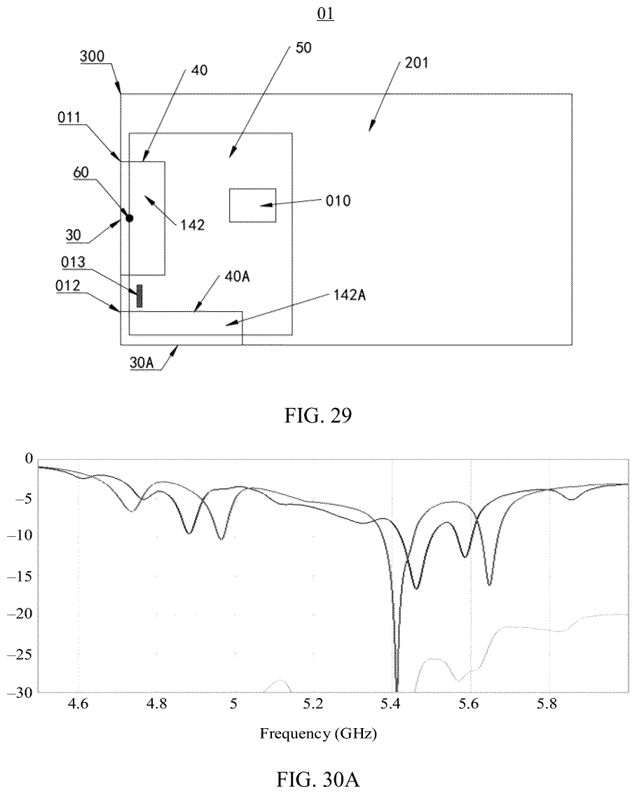

Refer to FIG. 29. In an implementation, a first antenna element 11 and a second antenna element 12 are disposed inside an electronic device 01. The cavity 142 and the slot structure 30 that are described above form the first antenna element 11. The second antenna element 12 includes a second conducting connection member 40A, and the second conducting connection member 40A is electrically connected between a first conducting layer and a second conducting layer. The first conducting layer, the second conducting connection member 40A, and the second conducting layer jointly enclose a second cavity 142A. The electronic device 01 is disposed with a second slot structure 30A. The second cavity 142A and the second slot structure 30A form a cavity-backed slot antenna, and the second slot structure 30A is a path for electromagnetic wave interconnection between the second cavity 142A and the outside of the electronic device 01. For a specific solution for designing the second cavity 142A and the second slot structure 30A, refer to a specific solution of designing a cavity 142 and a slot structure 30 provided in all the foregoing implementations. Details are not described again. The second antenna element 12 and the first antenna element 11 are adjacent to each other with a spacing component 13 in between. The spacing component 13 includes a conductive material, and the spacing component 13 is configured to improve isolation between the second antenna element 12 and the first antenna element 11. The spacing component 13 is a conductive structure, for example, a metal column or a metal elastic sheet electrically connected between the first conducting layer and the second conducting layer. In an implementation, both an operating frequency of the first antenna element 11 and an operating frequency of the second antenna element 12 include 5 GHz.

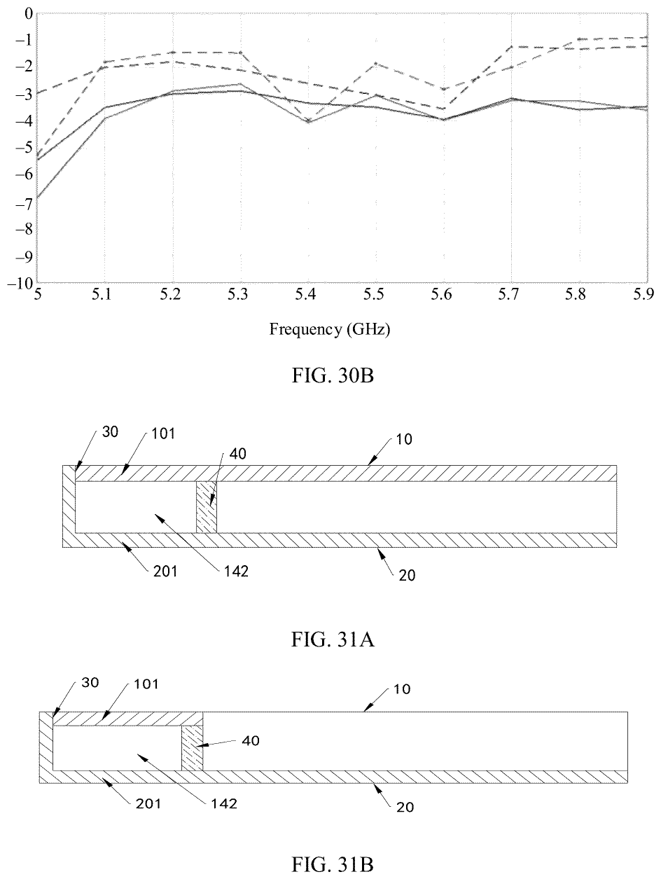

Refer to FIG. 30A and FIG. 30B. FIG. 30A is a diagram of S parameters of the first antenna element and the second antenna element in FIG. 29. FIG. 30B is a diagram of comparison between antenna radiation efficiency of the first antenna element and the second antenna element in FIG. 29.

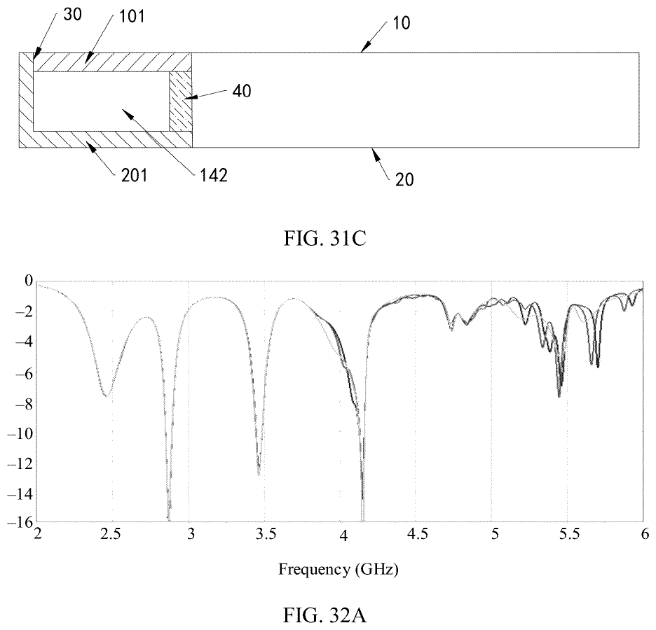

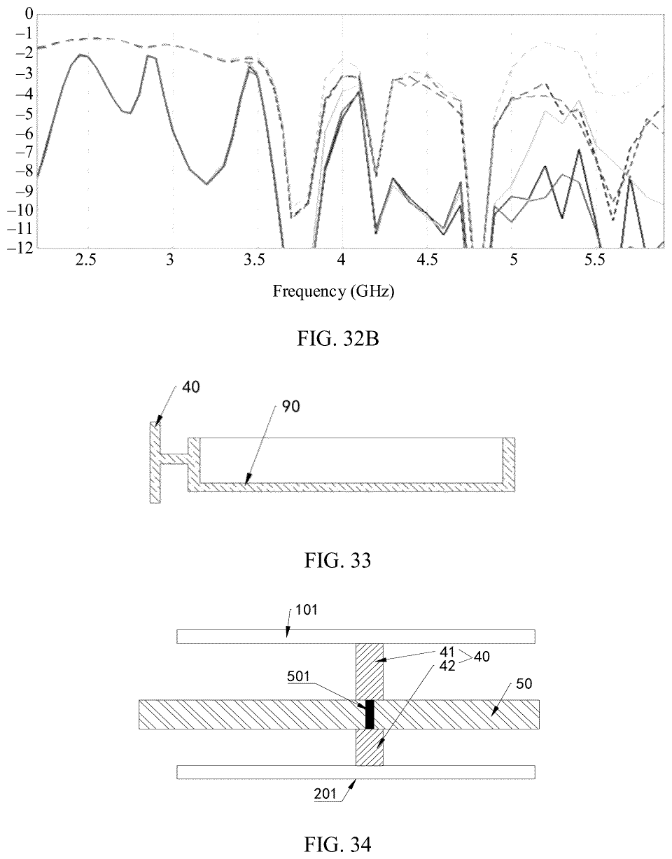

Refer to FIG. 31A, FIG. 31B, and FIG. 31C. In an implementation shown in FIG. 31A, a housing 20 is an all-metal rear housing, and a first conducting layer 201 covers a majority of or all of an area of the housing 20. A second conducting layer 101 is a shield layer of a display screen 10, and the second conducting layer 101 covers a majority of or all of the area of the display screen. In the implementation shown in FIG. 31B, compared with the implementation shown in FIG. 31A, the second conducting layer 101 is reduced to an edge position in a cavity 142, but the first conducting layer 201 still covers a majority of or all of the area of the housing 20. In the implementation shown in FIG. 31C, compared with the implementation shown in FIG. 31A, the second conducting layer 101 is reduced to an edge position in the cavity 142; and compared with the implementation shown in FIG. 31A, the first conducting layer 201 is reduced to an edge position in the cavity 142. In the three implementations shown in FIG. 31A, FIG. 31B, and FIG. 31C, although areas of the first conducting layer 201 and the second conducting layer 101 are different, performance of an antenna element formed by the cavity 142 and a slot structure 30 remains unchanged. Refer to FIG. 32A and FIG. 32B. FIG. 32A is a diagram of comparison between S curves of antenna elements according to the implementations shown in FIG. 31A, FIG. 31B, and FIG. 31C, and FIG. 32B is a diagram of comparison between radiation efficiency of the antenna elements according to the implementations shown in FIG. 31A, FIG. 31B, and FIG. 31C. A decrease in the areas of the first conducting layer 201 and the second conducting layer 101 has little impact on a low band, and a decrease in the area of the first conducting layer of the housing of the electronic device improves 5G Wi-Fi performance. Therefore, in an implementation, the housing of the electronic device may be a non-metal housing, and a metal layer is disposed only at a position corresponding to the cavity, so that 5G Wi-Fi performance of an antenna element can be ensured.

In an implementation, the conducting connection member is part of an assembly frame inside the electronic device, and the assembly frame is any one of or a combination of at least two of a battery compartment, a middle frame, and a camera assembly frame. FIG. 33 is a diagram of a structure in which a conducting connection member and a battery compartment in an electronic device are connected to each other according to an implementation of this disclosure. Refer to FIG. 33. In an implementation, the conducting connection member 40 and the battery compartment 90 are connected to each other and form a whole. The conducting connection member 40 may be a metal elastic sheet structure, a metal wall, or a metal column structure. When the battery compartment 90 is mounted in the electronic device, it is ensured that two ends of the conducting connection member 40 abut against a first conducting layer and a second conducting layer, to form a cavity architecture. In this solution, the conducting connection member and the battery compartment are disposed as an integrated structure to facilitate assembly and fixing. The battery compartment can be used as a battery holder, and can also fix the conducting connection member. In this way, the battery compartment has dual functions, not only helping save a space to implement a miniaturization design, but also helping ensure structural stability of the conducting connection member.

FIG. 34 is a diagram of a structure in which a conducting connection member and a circuit board in an electronic device are connected to each other according to an implementation of this disclosure. In an implementation, as shown in FIG. 34, a conducting connection member 40 is connected to a circuit board 50 inside a cavity. The conducting connection member 40 includes a first conducting member 41 and a second conducting member 42. One end of the first conducting member 41 is fixed to one surface of the circuit board 50, and the other end of the first conducting member 41 is electrically connected to a first conducting layer 201. One end of the second conducting member 42 is fixed to the other surface of the circuit board 50, and the other end of the second conducting member 42 is electrically connected to a second conducting layer 101. The first conducting member 41 and the second conducting member 42 are electrically connected through a line 501 in the circuit board 50. Specifically, the first conducting member 41 and the second conducting member 42 may be metal elastic sheet structures or metal column structures, and the line 501 in the circuit board 50 may be a structure, for example, a copper column or a through-hole, in the circuit board. In this solution, the conducting connection member is integrated onto the circuit board, and the cavity can be constructed by assembling the circuit board. The first conducting member and the second conducting member may be fixed onto the circuit board through a mounting process. The circuit board is used as a structure for holding a feed unit. In this solution, the conducting connection member is connected to the circuit board, and no other fixing structure needs to be added to fix the conducting connection member. This helps save a space, can easily implement miniaturization of the electronic device, and ensures structural stability of the conducting connection member. The first conducting member and the second conducting member may be elastic sheet structures that elastically abut against the first conducting layer and the second conducting layer, so that the cavity can have a continuous electric connection function, to ensure stability of the radiation performance of the cavity-backed slot antenna.

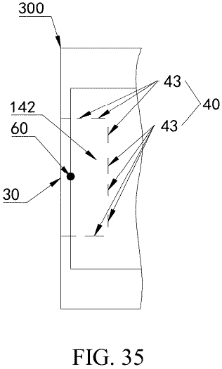

FIG. 35 is a diagram of a conducting connection member in an electronic device including a plurality of connection subunits according to an implementation of this disclosure. In an implementation, as shown in FIG. 35, at least part of the conducting connection member 40 includes a plurality of connection subunits 43, at least one of the connection subunits 43 is disposed at each edge in a width direction of a cavity 142, and a distance between adjacent connection subunits 43 is less than or equal to half of a wavelength corresponding to a center frequency of the operating band of the cavity 142.

The foregoing descriptions are merely specific implementations of this disclosure, but are not intended to limit the protection scope of this disclosure. Any variation or replacement within the technical scope disclosed in this disclosure shall fall within the protection scope of this disclosure. Therefore, the protection scope of this disclosure shall be subject to the protection scope of the claims.

What is claimed is:

1. An electronic device, comprising:
an internal space;
a housing comprising a first conducting layer;
a display screen comprising a second conducting layer, wherein the first conducting layer and the second conducting layer are layered in a thickness direction of the electronic device, and wherein the housing and the display screen jointly enclose the internal space;
a conducting connection member electrically connected between the first conducting layer and the second conducting layer; and
a cavity-backed slot antenna comprising:
a cavity having a length extending in an extension direction, having a width extending in a direction perpendicular to the extension direction and perpendicular to the thickness direction, and enclosed by the first conducting layer, the conducting connection member, and the second conducting layer, wherein a ratio of the length to the width is greater than or equal to 3; and
a slot structure having the length, disposed in the cavity, and extending in the extension direction.

2. The electronic device of claim 1, wherein the ratio is less than or equal to 10.

3. The electronic device of claim 2, wherein the ratio is greater than or equal to 4 and less than or equal to 6.

4. The electronic device of claim 2, further comprising:
a first antenna element comprising:
the cavity; and
the slot structure;
a second antenna element comprising a second conducting connection member electrically connected between the first conducting layer and the second conducting layer;
a spacing component, wherein the first antenna element is adjacent to the second antenna element, and wherein the spacing component is disposed between the first antenna element and the second antenna element; and
a cavity-backed slot antenna comprising:
a second cavity; and
a second slot structure, wherein the first conducting layer, the second conducting connection member, and the second conducting layer jointly enclose the second cavity.

5. The electronic device of claim 1, wherein a thickness of the cavity is greater than or equal to 1 mm in the thickness direction.

6. The electronic device of claim 1, wherein an operating band of the cavity is 2.4 gigahertz (GHz), the length is greater than or equal to 75 millimeters (mm) and less than or equal to 150 mm, the width is greater than or equal to 15 mm and less than or equal to 30 mm, or wherein the operating band is 5 GHz, the length is greater than or equal to 36 mm and less than or equal to 72 mm, and the width is greater than or equal to 7.2 mm and less than or equal to 14.4 mm.

7. The electronic device of claim 1, wherein an operating band of the cavity is 2.4 gigahertz (GHz), the length is greater than or equal to 75 millimeters (mm) and less than or equal to 100 mm, and the width is greater than or equal to 15 mm and less than or equal to 25 mm, or wherein the operating band is 5 GHZ, the length is greater than or equal to 36 mm and less than or equal to 48 mm, and the width is greater than or equal to 7.2 mm and less than or equal to 12 mm.

8. The electronic device of claim 1, wherein the housing is an integrated all-metal rear cover structure, wherein a periphery of the housing and a periphery of the display screen are joined to form an enclosed assembly gap surrounding the display screen, and wherein the slot structure is part of the assembly gap.

9. The electronic device of claim 1, further comprising a feed system disposed inside the cavity, wherein the feed system comprises a feed port, and wherein the first conducting layer comprises:
a bottom part disposed opposite to and spaced from the second conducting layer; and
a lateral part connected between the bottom part and a periphery of the display screen,
wherein a vertical distance between the feed port and the second conducting layer is a first distance, a vertical distance between the feed port and the bottom part is a second distance, and a vertical distance between the feed port and the lateral part is a third distance,
wherein when the first distance is the largest among the first distance, the second distance, and the third distance, the feed port feeds the second conducting layer,
wherein when the third distance is the largest, the feed port feeds the lateral part of the first conducting layer, and
wherein when the second distance is the largest, the feed port feeds the bottom part of the first conducting layer.

10. The electronic device of claim 1, wherein the display screen comprises:
a top edge;
a bottom edge; and
a lateral edge connected between the top edge and the bottom edge, and
wherein the slot structure is straight and is formed on the lateral edge or the top edge.

11. The electronic device of claim 1, wherein the display screen comprises:
a first edge; and
a second edge adjacent to the first edge,
wherein the slot structure is bent and is disposed in a connection area between the first edge and the second edge,
wherein a first part of the slot structure is formed on the first edge, and
wherein a second part of the slot structure is formed on the second edge.

12. The electronic device of claim 1, wherein the display screen comprises:
a first edge;
a second edge; and
a third edge disposed opposite to the first edge,
wherein the first edge, the second edge, and the third edge are sequentially connected,
wherein the slot structure is half-encircling,
wherein a first part of the slot structure is on the first edge,
wherein a second part of the slot structure is on the second edge, and
wherein a third part of the slot structure is on the third edge.

13. The electronic device of claim 1, further comprising an assembly frame, wherein the assembly frame comprises the conducting connection member, and wherein the assembly frame is at least one of a battery compartment, a middle frame, or a camera assembly frame.

14. The electronic device of claim 1, further comprising:
a circuit board having a first surface and a second surface, wherein at least part of the circuit board is disposed inside the cavity; and
a feed port disposed on the circuit board,
wherein at least part of the conducting connection member is connected to the circuit board, and
wherein the conducting connection member comprises:
a first conducting member having a first end and a second end, wherein the first end is fixed to the first surface of the circuit board, and wherein the second end of the first conducting member is electrically connected to the first conducting layer; and
a second conducting member electrically connected to the first conducting member through a line inside the circuit board and having a third end and a fourth end, wherein the third end is fixed to the second surface of the circuit board, and wherein the fourth end is electrically connected to the second conducting layer.

15. The electronic device of claim 1, wherein at least part of the conducting connection member comprises a plurality of connection subunits, wherein at least one of the connection subunits is disposed at each edge in a width direction of the cavity, and wherein a distance between adjacent connection subunits is less than or equal to half of a wavelength corresponding to a center frequency of an operating band of the cavity.

16. The electronic device of claim 1, wherein when the range is greater than or equal to 3 and less than or equal to 7, the cavity is configured to generate two or three resonance modes within 50% of a bandwidth of a lowest resonance frequency of the cavity.

17. The electronic device of claim 1, wherein when the range is greater than 7 and less than or equal to 10, the cavity is configured to generate four or more resonance modes within 50% of a bandwidth of a lowest resonance frequency of the cavity.

18. The electronic device of claim 1, further comprising a connection member is disposed inside the cavity, wherein the connection member comprises a conductive material and has a first end connected to the first conducting layer and a second end connected to the second conducting layer, and wherein a distance between the connection member and one end of the cavity is less than or equal to 0.25 times the length.

19. The electronic device of claim 18, wherein the cavity has two operating frequencies.

20. The electronic device of claim 1, further comprising:
a first antenna element comprising:
the cavity; and
the slot structure;
a second antenna element comprising a second conducting connection member electrically connected between the first conducting layer and the second conducting layer;
a spacing component, wherein the first antenna element is adjacent to the second antenna element, and wherein the spacing component is disposed between the first antenna element and the second antenna element; and
a cavity-backed slot antenna comprising:
a second cavity; and
a second slot structure, wherein the first conducting layer, the second conducting connection member, and the second conducting layer jointly enclose the second cavity.
